(19) United States
(12) Patent Application Publication
(10) Pub. No.: US 2013/0133386 A1
(43) Pub. Date: May 30, 2013

(54) METHODS AND SYSTEMS FOR PRODUCING ORGANIC FERTILIZER

(71) Applicant: WISErg Corporation, Redmond, WA (US)

(72) Inventors: Brandon Baker, Satsop, WA (US); James Downar, Seattle, WA (US); Chris Ashfield, Seattle, WA (US); Tim Robie, Seattle, WA (US); Lee Wilkerson, Stanwood, WA (US); Larry LeSueur, Sammamish, WA (US); Jose Lugo, Kirkland, WA (US)

(73) Assignee: WISErg Corporation, Redmond, WA (US)

(21) Appl. No.: 13/749,528

(22) Filed: Jan. 24, 2013

Related U.S. Application Data
(63) Continuation-in-part of application No. 13/191,251, filed on Jul. 26, 2011.
(60) Provisional application No. 61/400,433, filed on Jul. 27, 2010.
(60) Provisional application No. 61/590,728, filed on Jan. 25, 2012.

(51) Int. Cl. C05F 17/02

(52) U.S. Cl. CPC C05F 17/02
USPC 71/10; 435/287.1; 71/23; 435/286.5; 71/14

(57) ABSTRACT

The present application relates to systems and methods for producing organic fertilizer. The method may, for example, yield nutrient-rich fertilizer that may have various agricultural and other industrial uses.

### CROSS-REFERENCE TO RELATED APPLICATIONS

The present application is a continuation-in-part of U.S. application Ser. No. 13/191,251, filed Jul. 26, 2011, which claims the benefit of priority to U.S. application Ser. No. 61/400,433, filed Jul. 27, 2010. The present application also claims the benefit of priority to U.S. Application No. 61/590,728, filed Jan. 25, 2012. The contents of these applications are hereby incorporated by reference in their entirety.

### BACKGROUND

1. Field

The present application relates to processing organic material to obtain nutrient-rich components and biogas.

2. Description

Organic fertilizers are useful for assisting in the growth of agricultural crops, residential plants, and landscaping flora without the need for synthetic or petroleum-based fertilizers. It is known in the art that organic fertilizers have enhanced benefits over traditional fertilizers that extend beyond the plant to positively affect the health of soils. Compared to traditional fertilizers, organic fertilizers have been shown to decrease negative environmental impacts associated with nutrient leaching into the environment, and increase useful biotic activity in soils.

The organic fraction of municipal solid waste (OFMSW), and more specifically, the food waste subcomponent therein, is a nuisance and environmental waste issue. Rainwater percolates through landfills, where food waste is deposited, and leads to heavy metals and minerals leaching, thus contributing to the contamination of soils, surface water and ground water. Decaying waste emits greenhouse gasses which subsequently cause significant environmental concern. Food waste also causes odor, vector and rodent issues both in landfills and composting facilities, the latter of which have been specifically designed to recover food waste nutrition. In the United States alone, some 34 million tons of food waste are produced each year and nearly 33 million tons is committed to landfills for disposal, the cost of which is usually borne by the waste producer in the form of tipping fees.

Despite being considered waste that is unsuitable for human or animal consumption, a high level of valuable nutrition remains in the food waste that can be processed into various agricultural or other products. Agricultural products derived from organic waste, including food waste, have been shown to: (a) exhibit plant growth acceleration that equals or outperforms traditional, synthetic or petroleum based fertilizers; (b) increase the long-term health of carbon-depleted soils; and (c) command monetary premiums in distribution markets. It is therefore a useful economic and environment-sustaining endeavor to develop a process to produce fertilizers from food waste for the dual benefits of providing for nutrient-rich organic fertilizers for agricultural purposes, and to reduce the nuisance and cost issues related to traditional food waste disposal.

Additional economic and environmental benefits can be achieved by producing fertilizers that are approved for use in organic crop production by an accredited certifying agent. The use of food waste as a feedstock may produce fertilizers that are approved for use, whereas many traditional fertilizers derived from traditional synthetic and petroleum-based sources generally cannot be approved.

Anaerobic digestion is a biological process in which microorganisms break down a material in the absence (or limited presence) of oxygen. Although this may take place naturally within a landfill over extended periods of time, the term anaerobic digestion typically describes a contained and accelerated operation. Anaerobic digestion can be used for processing various waste materials, such as sewage or food waste.

Anaerobic digestion can yield components including biogas, digestate (or solid effluent), and liquid effluent. Biogas is generated by the microorganisms digesting the organic material and may be comprised of, including but not limited to; methane, carbon dioxide, water, and other gases. This biogas, and in particular methane, can be used as an alternative energy source. The digestate (solid effluent) may be further processed and used as compost. The liquid effluent may be disposed (for example, via municipal wastewater treatment), or may be utilized as a nutrient-rich organic fertilizer, or may be further nutritionally augmented with organic material and be utilized as a nutrient-rich fertilizer, or may be further nutritionally augmented with synthetic material and be utilized as a nutrient-rich fertilizer, or may be nutritionally augmented with both organic and synthetic material and utilized as a fertilizer.

### SUMMARY

Disclosed herein are systems and methods for processing organic materials. The process may, for example, yield nutrient-rich fertilizers that may have various agricultural uses. The method may yield biogas that has various uses as a clean energy source of heat and/or electricity. The method can include a two-stage anaerobic digestion process. In some embodiments, the method can include a two-stage anaerobic digestion process, a proteolytic digestion process, a nutrient addition process, and a product recovery process.

The method can include, in some embodiments, forming a slurry from components comprising liquid and organic material; combining the slurry with microorganisms to form a biomass; anaerobically digesting the organic material in the biomass in a primary reaction phase; and at least partially separating liquid components from the digested biomass. In some embodiments, no more than about 0.02 m³ (about 20 L) of methane are produced from the anaerobic digestion per kilogram of organic material. In some embodiments, the method can include collecting the organic liquid fraction and collecting the solid fraction from the separated liquid in the primary reaction phase; sequestering the solid fraction from further processing; combining the organic liquid fraction with microorganisms to form a biomass in a secondary reaction phase; collecting the liquid effluent from the secondary reaction phase; and collecting or emitting the biogas from the secondary reaction phase. In some embodiments, the liquid effluent from the secondary phase (base fertilizer) has a total nitrogen content of at least 0.01% (100 PPM), and a potassium content (measured as grams K₂O per liter of solution) of at least 0.005% (50 PPM). In some embodiments the base fertilizer has a total nitrogen content of at least 0.1% (1,000 PPM), and a potassium (K₂O) content of at least 0.05% (500 PPM). In some embodiments the base fertilizer has a total nitrogen content of at least 0.5% (5,000 PPM), and a potassium (K₂O) content of at least 0.25% (2,500 PPM). In some embodiments the base fertilizer has a total nitrogen content of at least 1.0% (10,000 PPM), and apotassium (K₂O) content of at least 0.5% (5,000 PPM). In some embodiments the base fertilizer has a total nitrogen content of at least 2.0% (20,000 PPM), and apotassium (K₂O) content of at least 1.0% (10,000 PPM). In some embodiments the base fertilizer has a total nitrogen content of at least 3.0% (30,000 PPM), and apotassium (K₂O) content of at least 2.0% (20,000 PPM).

The method can include in some embodiments, careful weighing of input organic material so as to accurately proportion various stages of mixing operations and accurately predict content of the nutrient enriched product fractions.

The method can include, in some embodiments, pasteurizing the base fertilizer; forming a mixture with a protein containing material; combining the protein material mixture with proteases; and proteolytically digesting, or enzymatically digesting the protein material to produce a nitrogen-enriched mixture. The method can include, in some embodiments, adding materials containing potassium, phosphorus, magnesium, calcium, iron, sulfur, manganese, chloride, nickel, cobalt, molybdenum, selenium, or zinc, or combinations thereof to the base fertilizer to form a nutrient-rich mixture. The method can include, in some embodiments, combining the nitrogen-enriched mixture with the nutrient-rich mixture to form a combined mixture; adjusting the pH of the mixture; concentrating the mixture; and separating the mixture to collect a liquid Fertilizer Product fraction. In some embodiments, the total nitrogen content of the fertilizer is at least 1.0% (10,000 PPM). In some embodiments, the total potassium (K₂O) content is at least 0.5% (5,000 PPM). In some embodiments, the nitrogen, potassium, phosphorous and other secondary nutrients (Ca, Mg, S) and micronutrients (e.g., B, Cl, Co, Cu, Fe, Mn, Mo, Ni, Se, and Zn, among others) exist in sufficient concentrations as to promote plant growth efficacy and provide for economic benefit.

Also disclosed are systems for processing organic materials. The systems may, in some embodiments, be configured to perform the method of processing organic materials.

### BRIEF DESCRIPTION OF THE DRAWINGS

FIG. 1A is a flow diagram representing one example of a first-phase anaerobic digestion process within the scope of the present application.

FIG. 1B is a flow diagram representing one example of a second-phase anaerobic digestion process within the scope of the present application.

FIG. 2 is a flow diagram representing one example of a process for increasing the nutrient content of organic material.

FIG. 3 is a block diagram illustrating one example of system 300 for processing organic materials within the scope of the present application.

### DETAILED DESCRIPTION

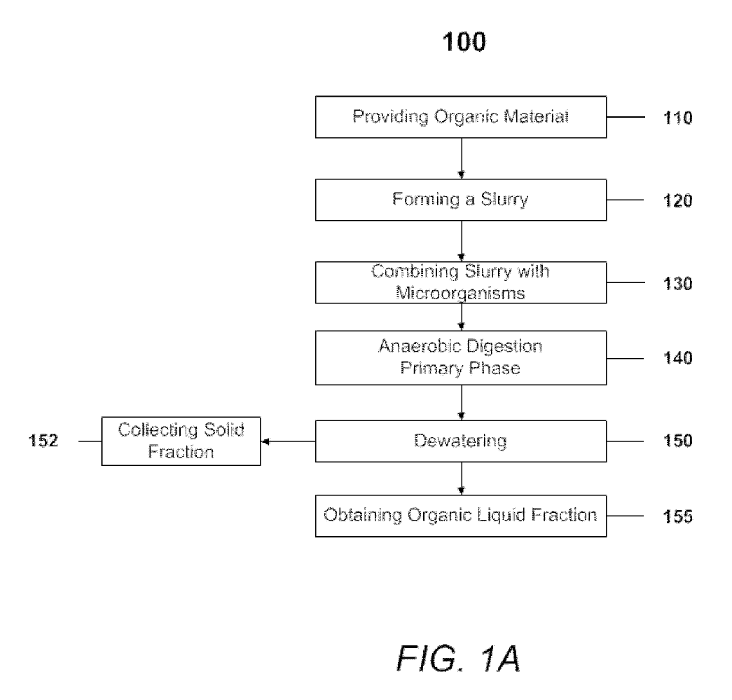

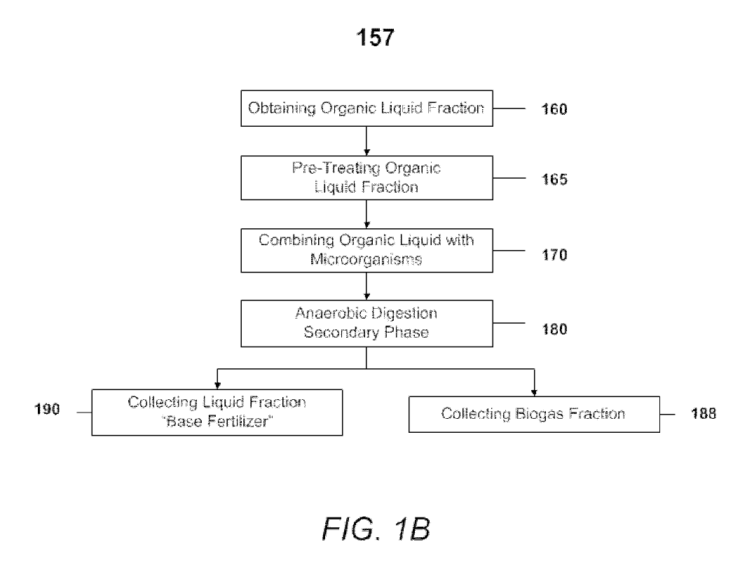

FIG. 1A is a flow diagram representing one example of method 100 for processing organic materials using a first-phase anaerobic digestion process within the scope of the present application. As illustrated in FIG. 1A, method 100 may include one or more functions, operations, or actions as illustrated by one or more operations 110-155. Operations 110-155 may include “Providing Organic Material” operation 110, “Forming a Slurry” operation 120, “Combining Slurry with Microorganisms” operation 130, “Anaerobic Digestion Primary Phase” operation 140, “Dewatering” operation 150, “Collecting Solid Fraction” operation 152, and “Obtaining Organic Liquid Fraction” operation 155.

In FIG. 1, operations 110-150 are illustrated as being performed sequentially, with operation 110 first and operation 150 last. It will be appreciated however that these operations may be re-ordered as convenient to suit particular embodiments, and that these operations or portions thereof may be performed concurrently in some embodiments.

Method 100 may begin at operation 110, “Providing Organic Material.” In operation 110, organic material is provided for processing. The organic material is not particularly limited, and may be any organic material that is suitable for anaerobic digestion. Non-limiting examples of organic material that may be provided in operation 110 include: raw sewage, animal waste (e.g, manure), soluble solid wastes (e.g., cellulose-based paper products, such as cardboard), food waste, and the like. In some embodiments, the organic material is food waste. The food waste can be, for example, pre- or post-consumer food waste. Some examples of food waste include, but are not limited to, dairy (e.g., milk, cheese, etc.), meat (e.g., poultry, beef, fish, pork, etc.), grains (e.g, bread, crackers, pasta), fruits, and vegetables. As one example, the food waste may be unsold or expired food from a food retailer. As another example, food waste may be uneaten food or scraps from a restaurant or the delicatessen section of a grocery store.

Operation 110 may be followed by operation 120, “Forming a slurry.” In operation 120, the organic material can be formed into a slurry. In some embodiments, the organic material may be reduced to particulate liquid and small particulates (e.g., through comminution). Any suitable method for comminuting the organic materials can be used. For example, the organic waste may be subjected to grinding, cutting, crushing, milling, macerating, hydro-pulping, and the like. The size of the particulate formed from the organic material may vary and may be selected, in part, upon the conditions for anaerobic digestion. The particulate may have an average size of, for example, no more than about 10 cm; no more than about 8 cm; no more than about 5 cm; no more than about 2 cm; or no more than about 1 cm. The particulate may have an average size of, for example, at least about 500 μm; at least about 1 mm; at least about 2 mm; or at least about 5 mm. In some embodiments, particulate has an average size of about 1 mm to about 10 cm. Non-limiting examples for the average particle size include about 2 mm, about 4 mm, about 6 mm, about 8 mm, about 1 cm, or about 2 cm.

The organic material may, in some embodiments, be combined with a liquid to form a slurry. The organic material may be combined with a liquid before, during, and/or after the organic material is comminuted. The liquid can be, for example, water, leachate, or combinations thereof. The water may be, for example, potable water from a municipal water source or a well. As used herein, “leachate” includes liquid components isolated from an anaerobic digestion of organic materials (e.g., liquid components obtained from dewatering operation 150 in FIG. 1A, which is discussed further below). The leachate may, in some embodiments, be unpurified leachate that has not been subjected to purification (e.g., the leachate has not been purified after being obtained from dewatering operation 150 in FIG. 1). In some embodiments, the liquid is water. In some embodiments, the liquid is a mixture including water and leachate.

The relative amount of liquid combined with the organic material can be selected to vary the characteristics of the slurry. The relative amount is not particularly limited and may vary depending upon various factors, such as the type of organic material and the anaerobic digestion conditions. The amount of organic material in the slurry may be, for example, at least about 40% (w/w); at least about 50% (w/w); at least about 60% (w/w); at least about 75% (w/w); at least about 90% (w/w); or at least about 95% (w/w). The amount of organic material in the slurry may be, for example, no more than about 100% (w/w); no more than about 95% (w/w); no more than about 90% (w/w); no more than about 75% (w/w); no more than about 60%; no more than about 50%; or no more than about 45%. In some embodiments, the amount of organic material in the slurry is from about 40% to about 100%. Non-limiting examples for the amount of organic material in the slurry include about 50%, about 67%, about 75%, about 80%, about 83%, or about 86%. In some embodiments, the balance of the slurry is the liquid combined with the organic material.

As noted above, the liquid may include a mixture of leachate and water. The relative amount of leachate and water added to the slurry is not limited. The relative amount of leachate to water can be, for example, no more than about 100% (w/w); no more than about 50% (w/w); no more than about 35% (w/w); or no more than about 20% (w/w). In some embodiments, no leachate is combined with the organic material.

In some embodiments, the amount of leachate combined with the organic material can be determined based on the nutrient content in the leachate. For example, the leachate may be combined with the organic material if the nitrogen content in the leachate is below a pre-determined threshold; however, no leachate may be combined with the organic material if the nitrogen content is above the pre-determined threshold. The threshold can be, for example, in the range of about 0.05% to about 3% nitrogen. Some non-limiting examples for the threshold include about 0.1%, about 0.2%, about 0.3%, about 0.4%, about 0.5%, about 1%, about 1.5%, about 2%, about 2.5%, or about 3% nitrogen. In some embodiments, the amount of leachate combined with the organic material may be inversely proportional to the amount nitrogen in the leachate. For example, a higher volume of leachate may be combined with the organic material when the nitrogen content is less than 0.1% compared to when the leachate has a nitrogen content in the range of 0.1% to 0.2%.

Combining liquid with the organic material is optional in operation 120. For example, the organic material may be comminuted to form a slurry without adding additional liquids. Thus, in some embodiments, the amount of organic material in the slurry can be 100%.

Operation 120 may be followed by operation 130, “Combining Slurry with Microorganisms.” In operation 130, the slurry is combined with microorganisms that are suitable for performing anaerobic digestion to obtain a biomass. The type of microorganisms is not particularly limited, and numerous seeds are known in the art for anaerobic digestion. For example, a mesophilic seed was provided to the inventors by Penford Food Ingredients Co. (Richland, Wash.). In some embodiments, the microorganisms include bacteria. The bacteria may include, for example, hydrolytic bacteria, acetogenic bacteria, and acidogenic bacteria. In some embodiments, the microorganisms are mesophilic. In some embodiments, the microorganisms are thermophilic. In some embodiments the organisms are a mixture of mesophilic and thermophilic.

The microorganisms may, in some embodiments, be present in an at least partially digested biomass. The microorganisms may be suspended within the biomass. Thus, for example, the microorganisms may be combined with the slurry by combining an at least partially digested biomass with the slurry. The biomass and slurry may be mixed to suspend (or disperse) the microorganisms in the slurry.

In some embodiments, the microorganisms are carried by a solid support, such as, for example, rough stones, slats, plastic media, microcarriers, media particles, a biotower, a rotating biological contactor, and the like. Combining the slurry with the microorganisms may include, for example, contacting the slurry with a solid support including the microorganisms.

In some embodiments elements obtained from the leachate such as fats, oils or greases may be used as a biochemical support for the microorganisms.

As will be appreciated by the skilled artisan, guided by the teachings of the present application, the order of operations 120 and 130 can be interchangeable, and may occur at about the same time or at different times. For example, the microorganisms may be first combined with the organic material and subsequently comminuted to obtain a slurry. As another example, the organic material can be comminuted and subsequently combined with a liquid and microorganisms at about the same time.

Operation 130 may be followed by operation 140, “Anaerobic Digestion.” In operation 140, the biomass obtained in operation 130 is maintained at conditions for anaerobic digestion to occur. The particular conditions may vary depending on various factors, including the type of microorganisms, the organic material, etc. The anaerobic digestion may, in some embodiments, produce low amounts of methane. For example, in contrast to anaerobic digestion processes intended to improve methane production, operation 130 may include maintaining conditions that limit methane production (e.g., limit production of methane by methanogenic bacteria). In some embodiments operation 130 may include operating conditions that favor acetogenic organisms and their byproducts.

The biomass may, for example, be maintained at a pH that is effective for the microorganisms to anaerobically digest the organic materials. In some embodiments, the biomass is maintained at a pH that is effective to limit methane production. The pH of the biomass may, in some embodiments, be maintained within a range of about 3.5 to about 8. The biomass may be maintained at a pH of, for example, at least about 3.5; at least about 4; at least about 5; at least about 6; at least about 7; or at least about 7.5. The biomass may be maintained at a pH of, for example, no more than about 8, no more than about 7, no more than about 6; no more than about 5; or no more than about 4. In some embodiments, the pH is maintained within a range of about 3.5 to 5.5. In some embodiments, the pH is maintained within a range of about 5.5 to 7.

The pH can be maintained, in some embodiments, by measuring the pH at appropriate time intervals during anaerobic digestion and adding a pH modifying agent, if necessary, to adjust the pH. Non-limiting examples of pH modifying agents include carboxylic, phosphoric and sulfonic acids, acid salts (e.g., monosodium citrate, disodium citrate, monosodium malate, etc.), alkali metal hydroxides such as sodium hydroxide, calcium hydroxide, potassium hydroxide, carbonates (e.g., sodium carbonate, bicarbonates, sesquicarbonates), borates, silicates, phosphates (e.g., monosodium phosphate, trisodium phosphate, pyrophosphate salts, etc.), imidazole and the like.

The temperature of the biomass may, in some embodiments, be maintained at a temperature that is effective for the microorganisms to anaerobically digest the organic materials. In some embodiments, the biomass is maintained at a temperature in a range of about 77° F. to about 105° F. during the anaerobic digestion. For example, the biomass may include mesophilic microorganisms that exhibit increased digestion at about 77° F. to about 105° F. In some embodiments, the biomass is maintained at a temperature in a range of about 90° F. to about 98° F. during the anaerobic digestion. In some embodiments, the biomass is maintained at a temperature in a range of about 120° F. to about 135° F. during the anaerobic digestion. For example, the biomass may include thermophilic microorganisms that exhibit increased digestion at about 120° F. to about 135° F.

The relative amount of organic material to liquids may, in some embodiments, be maintained within a range that is effective for the microorganisms to anaerobically digest the organic materials. The relative amount of organic material to liquids may, for example, be maintained by forming the appropriate slurry mixture of organic materials and liquid as discussed above with respect to operation 120. For example, no liquids may be removed from the biomass during anaerobic digestion, and therefore the relative amount is maintained at the initial ratio provided in the slurry at operation 120. In some embodiments, leachate (which includes at least a portion of the liquids in the biomass) is removed from the biomass during the anaerobic digestion. The leachate may be removed periodically (e.g., daily) or continuously. Thus, in some embodiments, additional liquid may be combined with the biomass to maintain the relative amount of organic material to liquid within a range. In some embodiments, additional liquid is combined with the biomass to maintain the relative amount of organic material to liquid to be about the same as the slurry initially combined with the microorganisms at operation 130.

The amount of organic material in the biomass may be maintained during anaerobic digestion at, for example, at least about 40% (w/w); at least about 50% (w/w); at least about 60% (w/w); at least about 75% (w/w); at least about 90% (w/w); or at least about 95% (w/w). The amount of organic material in the biomass may be maintained during anaerobic digestion at, for example, no more than about 100% (w/w); no more than about 95% (w/w); no more than about 90% (w/w); no more than about 75% (w/w); no more than about 60%; no more than about 50% (w/w); or no more than about 45% (w/w). In some embodiments, the amount of organic material in the biomass may be maintained during anaerobic digestion at about 40% to about 100% (w/w). Non-limiting examples for the amount of organic material in the biomass that may be maintained during anaerobic digestion include about 50%, about 67%, about 75%, about 80%, about 83%, or about 86%. In some embodiments, the balance of the biomass is the liquid and microorganisms.

The average time period for anaerobically digesting the organic materials may also vary. In some embodiments, the average time period for anaerobically digesting the organic materials can be in the range of about 1 day to about 14 days. For example, the average time period for anaerobically digesting the organic materials can be about 1 day, about 2 days, about 3 days, about 4 days, about 5 days, about 6 days, about 7 days, about 8 days, about 9 days, about 10 days, about 11 days, about 12 days, about 13 days, about 14 days, or any range including any two of these values.

The biomass may, in some embodiments, be mixed during the anaerobic digestion. For example, the biomass can be mixed rotating one or more blades to stir the biomass. As another example, the biomass can be mixed by recirculating the biomass within a reservoir, such as by pumping biomass from a lower portion of a reservoir to an upper portion of the reservoir. The mixing may be continuous or periodic. In some embodiments, the mixing can be periodic at predetermined intervals (e.g., about every ten minutes).

In some embodiments, additional slurry may be added during the anaerobic digestion. For example, organic material may be provided periodically (e.g., daily) and added to the biomass during the anaerobic digestion according to operations 110-130. As one example, the anaerobic digestion may begin with an amount of organic material on a first day, and about the same amount of organic material is added to the biomass during anaerobic digestion each day until day seven. The anaerobic digestion may then be discontinued (or limited) for all or a portion of the organic material (e.g., by cooling the material to a temperature that limits digestion, such as in embodiments for operation 150 disclosed below). The present application is not limited to any particular rate of adding additional slurries to the anaerobic digestion.

The amount of methane produced during the anaerobic digestion may be low relative to conventional methods. For example, the amount of methane yielded may be less than those produced by the processes described in U.S. Pat. No. 6,846,343, the contents of which are hereby incorporated by reference in their entirety. In some embodiments, no more than about 0.02 m³ of methane per kilogram of organic material is produced by the anaerobic digestion in operation 140. In some embodiments, no more than about 0.01 m³ of methane per kilogram of organic material is produced by the anaerobic digestion in operation 140. In some embodiments, no more than about 0.005 m³ of methane per kilogram of organic material is produced by the anaerobic digestion in operation 140. In some embodiments, no more than about 0.0001 m³ of methane per kilogram of organic material is produced by the anaerobic digestion in operation 140. In some embodiments, no more than about 0.02 m³ of methane per kilogram of organic material is produced during the method. In some embodiments, no more than about 0.01 m³ of methane per kilogram of organic material is produced during the method. In some embodiments, no more than about 0.005 m³ of methane per kilogram of organic material is produced during the method. In some embodiments, no more than about 0.001 m³ of methane per kilogram of organic material is produced during the method.

The present application appreciates that exposing the microorganisms to at least small amounts of oxygen may, in some embodiments, limit methane production during anaerobic digestion. Thus, as used herein, the term “anaerobic digestion” is understood to include the breakdown of organic material with limited amounts of oxygen (as well as the absence of oxygen). For example, anaerobic digestion can occur when the oxygen content is sufficiently low that microorganisms primarily (or substantially entirely) metabolize organic materials by fermentation. In some embodiments, the microorganisms are exposed to an amount of oxygen that is effective to reduce methane production. The volume percentage of oxygen gas dissolved in solution in the biomass relative to a total volume of gas dissolved in solution in the biomass may, for example, be at least about 2%; at least about 3%; at least about 4%; at least about 5%; or at least about 8%. The volume percentage of oxygen gas dissolved in solution in the biomass relative to a total volume of gas dissolved in solution in the biomass may, for example, be no more than about 20%; no more than about 15%; no more than about 10%; no more than about 8%; no more than about 5%; or no more than about 4%. In some embodiments, the volume percentage of oxygen gas dissolved in solution in the biomass relative to a total volume of gas dissolved in solution in the biomass is about 2% to about 21%. In some embodiments, the volume percentage of oxygen gas dissolved in solution in the biomass relative to a total volume of gas dissolved in solution in the biomass is about 2% to about 8%.

Operation 140 may be followed by operation 150, “Dewatering.” In operation 150, leachate is separated from the digested biomass obtained in operation 140. Numerous methods of dewatering are known in the art and are within the scope of the present application. Non-limiting examples of the method for dewatering the biomass include filtering, centrifuge, sedimentation, screw press, belt-filter press, and the like.

The dewatering may, in some embodiments, be performed continuously or periodically during anaerobic digestion. For example, the biomass may be filtered through a screen periodically (e.g., at least daily) to separate at least a portion of the leachate from the biomass. As another example, the biomass may continuously contact a screen configured to slowly separate water from the biomass (e.g., a screen with a sufficiently small size). As discussed above, in some embodiments, water may be added to the biomass during or after dewatering to maintain the relative amount of organic material to liquid.

In some embodiments, the leachate removed during dewatering may be received in a liquid reservoir for storing the leachate. The leachate may be stored, for example, in the liquid reservoir at a temperature below about 70° F. In some embodiments, at least a portion of the leachate is recirculated into to a biomass for further anaerobic digestion. For example, as discussed above, a portion of the leachate in the liquid reservoir may be combined with the organic material when forming the slurry at operation 120. As another example, the leachate may be directly added to the biomass during anaerobic digestion. As discussed above, in some embodiments, the amount of recirculated leachate can be determined, at least in part, by the nutrient content of the leachate (e.g., nitrogen content).

The leachate yielded during dewatering may, for example, be a nutrient-rich liquid that is suitable for further processing into fertilizer. The amount of nitrogen in the leachate may be, for example, at least about 0.1%; at least about 0.2%; at least about 0.3%; at least about 0.4%; at least about 0.5%; at least about 0.6%; at least about 0.8%; at least about 1%; at least about 1.5%; at least about 2%; at least about 2.5%; or at least about 3%. In some embodiments, the amount of nitrogen in the leachate can be at least about 0.1%. In some embodiments, the amount of nitrogen in the leachate can be at least about 0.5%. In some embodiments, the amount of nitrogen in the leachate can be at least about 1%.

The solids remaining after dewatering may be maintained under anaerobic digestion conditions (e.g., recirculate to a reservoir where anaerobic digestion conditions are maintained), or can be received in a solids reservoir. The destination of the solids may, in some embodiments, depend on the frequency of dewatering and the targeted average time period for anaerobic digestion. Solids may, for example, be received in the solids reservoir when a desired average time period for anaerobic digestion is achieved (e.g., the solids have been anaerobically digested for 1 to 14 days, or any time period disclosed above with respect to embodiments of operation 140). In some embodiments, the dewatering process may be different depending upon the destination of the solids after dewatering. For example, the biomass may be filtered using a screen when it is desired to maintain the solids under anaerobic digestion, and the biomass may be subject to a screw press when the solids will be placed in the solids reservoir. The solids yielded during dewatering may, for example, be used as volume-reduced compostable solid that may be subsequently converted into soil amendment.

Although, preferably, most or substantially all of the leachate in the biomass may be separated from the biomass before solids are placed into the solids reservoir, it is appreciated that at least a portion of the leachate may remain in the solids that are placed in the solids reservoir after dewatering. In some embodiments, at least about 40% of the leachate is separated from the digested biomass before placing solids in the solids reservoir. In some embodiments, at least about 50% of the leachate is separated from the digested biomass before placing solids in the solids reservoir. In some embodiments, at least about 60% of the leachate is separated from the digested biomass before placing solids in the solids reservoir. In some embodiments, the solids reservoir is maintained at a temperature below about 70° F.

All or a portion of the biomass may be removed from anaerobic digestion to perform dewatering. For example, anaerobic digestion may occur in a reservoir and the entirety of the biomass may be removed from the reservoir when dewatering. In some embodiments, at least a portion of the biomass will remain for additional anaerobic digestion. The portion of remaining biomass may provide microorganisms for combining with a new slurry of organic material. Thus, for example, the remaining biomass can be combined with a slurry to perform embodiments of operation 130 for a new batch of organic material. In some embodiments, no more than about 90% of the biomass undergoing anaerobic digestion is removed during dewatering. In some embodiments, no more than about 80% of the biomass undergoing anaerobic digestion is removed during dewatering.

In some embodiments, the method is performed in a closed system. For example, the method is performed within a closed structure that limits or controls the exchange of materials with the structure. For example, the operations 110-150 may be performed within a housing having a finite number of inlets and outlet for the organic material, liquids, biogas, leachate, solids, etc. The structure may limit the release of volatile organic compounds, volatile fatty acids, and hydrogen sulfide, or prevent exposing the microorganisms to excess oxygen.

In some embodiments, the method may include filtering the biogas produced during anaerobic digestion. In some embodiments, volatile organic compounds, hydrogen sulfide, or volatile fatty acids are removed from the biogas. The volatile fatty acids can be, for example, acetic acid, butyric acid, or propionic acid. As one example, the anaerobic digestion may be performed in a closed system, where biogas is released through a carbon filter that absorbs volatile organic compounds, hydrogen sulfide, or volatile fatty acids in the biogas.

Operation 150 may be followed by operation 155, “Obtaining Organic Liquid Fraction.” In operation 155, the liquid components from operation 150 are obtained. Thus, for example, operation 155 can include obtaining leachate as disclosed above and/or in U.S. application Ser. No. 13/191,251 from the dewatering operation. However, the organic liquid fraction may obtained from other processes for forming an organic liquid fraction, such as settling, chelation, or precipitation. In some embodiments, operation 155 may include storing the organic liquid fraction (e.g., leachate) at a temperature below 70° F.; below 100° F.; or below 135° F. The organic liquid fraction may, for example, be stored at a temperature below 70° F.; below 100° F.; or below 135° F. for at least 1 day; at least 2 days; at least 3 days; at least 4 days; at least 5 days; at least 1 week; at least 2 weeks; at least 1 months; or at least 2 months.

FIG. 1B is a flow diagram representing one example of method 157 for processing organic materials using a second-phase anaerobic digestion process within the scope of the present application. As illustrated in FIG. 1B, method 157 may include one or more functions, operations, or actions as illustrated by one or more operations 160-190. Operations 160-190 may include “Obtaining Organic Liquid Fraction” operation 160, “Pre-treating Organic Liquid Fraction” operation 165, “Combining Organic Liquid with Microorganisms” operation 170, “Anaerobic Digestion Secondary Phase,” operation 180, “Collecting Biogas Fraction,” operation 188, and “Collecting Liquid Fraction (“Base Fertilizer”)”, operation 190.

Method 157 may begin at operation 160, “Obtaining Organic Liquid Fraction.” In some embodiments, operation 160 can be the same as operation 155 in method 100. Thus, for example, the organic liquid fraction obtained from method 100 may be used as the input material for method 157. Consequently, some embodiments of the present application include a process that performs method 100 and method 157. In some embodiments, method 100 and method 157 are completed sequentially, or at about the same time.

Method 157 may, in some embodiments, be completed at a different location than method 100. For example, method 100 may be completed using a first system on-site where organic material (e.g., food waste) is produced. The organic liquid fraction may then be transported (e.g., by truck) to a second system to perform method 157. The first system and the second system may, for example, be separated by a distance of at least 1 mile; at least 5 miles; at least 10 miles; or at least 25 miles.

Operation 160 may be followed by operation 165, “Pre-Treating Organic Liquid Fraction.” In some embodiments, the organic liquid fraction is treated to reduce the solids content, the Chemical Oxygen Demand (“COD”) content, or other content. Any suitable method known to the skilled artisan may be used to reduce the solids content, COD content, or other content. Non-limiting examples of known methods for reducing solids, COD, or other content include settling, clarification, dilution, centrifugation, filtering, heating, treatment with alkali or acidic chemicals, treatment with flocculants, or combinations thereof.

In some embodiments, operation 165 can include settling to reduce the solids, COD, or other content. For example, the organic liquid (e.g., resulting from operation 160) can be allowed to settle for a time period sufficient to separate the liquid into a sludge layer and a settled layer. The time period for separation may be, for example, at least 1 hour; at least 3 hours; at least 8 hours; at least 12 hours; at least 24 hours; at least 48 hours; or at least 72 hours. The sludge layer can then be decanted or otherwise removed, leaving the settled organic liquid layer. In some embodiments, the settled organic liquid layer may have a COD content of below a predetermined amount. The COD content may be, for example, no more than 50 grams per liter (g/L), no more than 75 g/L, no more than 100 g/L, no more than 125 g/L; or no more than 150 g/L. In some embodiments, the settled organic liquid layer can have a Total Solids (TS) of below a predetermined amount. The TS content may be, for example, no more than 1% (w/w); no more than 5% (w/w); no more than 7.5% (w/w); no more than 5% (w/w); no more than 7.5% (w/w); no more than 10% (w/w); or no more than 15% (w/w).

In some embodiments, the settled layer is diluted with liquid. In some embodiments, the settled layer is diluted with water. In some embodiments, the settled layer is diluted with tap water. In some embodiments, the settled layer is diluted with deionized water. In some embodiments, the settled layer is diluted with dechlorinated water. Non-limiting examples of dechlorinating tap water include chemical treatment with sodium thiosulfate or other chemical treatment, evaporation, filtering, and other methods that one skilled in the art may employ to suit such purposes. In some embodiments, the settled layer is diluted with base fertilizer. The mixture of the settled layer and dilutive liquid is allowed to clarify. The mixture can, for example, be allowed to clarify over a period of at least 20 minutes; over a period of at least 1 hour; over a period at least 2 hours; over a period of at least 5 hours; over a period of at least 10 hours; or over a period of at least 24 hours. The settling and clarification procedures indicated may be performed sequentially in any order, mutually exclusive, simultaneously, or not at all. When operation 165 is subject to diluting with a liquid, it can be referred to as clarifying.

In some embodiments, operation 165 may include only settling. In some embodiments, operation 165 may include only clarifying. In some embodiments operation 165 includes settling and clarifying occurring sequentially, and in no particular order.

In some embodiments, operation 165 may yield an organic liquid (e.g., the settled organic liquid layer and/or clarified organic liquid layer) having a COD of below a predetermined amount. The COD content may be, for example, no more than 5 grams per liter (g/L), no more than 10 g/L, no more than 20 g/L, no more than 25 g/L; or no more than 50 g/L. In some embodiments, operation 165 may yield an organic liquid (e.g., the settled organic liquid layer and/or clarified organic liquid layer) having a TS of below a predetermined amount. The TS content may be, for example, no more than 0.5% (w/w); no more than 1% (w/w); no more than 2% (w/w); no more than 3% (w/w); no more than 5% (w/w); or no more than 10% (w/w).

Operation 165 may be followed by operation 170, “Combining Organic Liquid with Microorganisms.” In operation 170, the settled or clarified organic liquid is combined with microorganisms that are suitable for performing anaerobic digestion to obtain a liquid effluent and biogas. The type of microorganisms is not particularly limited, and numerous seed granules are known in the art for anaerobic digestion. For example, mesophilic seed granules were provided to the Applicants by Penford Food Ingredients Co. (Richland, Wash.). In some embodiments, the microorganisms include bacteria. The bacteria may include, for example, hydrolytic bacteria, acetogenic bacteria, acidogenic bacteria, and methanogenic bacteria. In some embodiments, the microorganisms are mesophilic. In some embodiments, the microorganisms are thermophilic.

The microorganisms may, in some embodiments, be present in a seed granule colony. Thus, for example, the microorganisms may be combined with the organic liquid with the seed granules to form a biomass. The seed granules and organic liquid may be mixed to suspend (or disperse) the microorganisms in the biomass. The seed granules and organic liquid may be mixed to suspend (or disperse) the microorganisms via an upward flowing fluidized bed in the biomass. In some embodiments, the microorganisms may mix with the organic liquid to form a biomass.

In some embodiments, the microorganisms are carried by a solid support, such as, for example, rough stones, slats, plastic media, microcarriers, media particles, a biotower, a rotating biological contactor, or the like. Combining the slurry with the microorganisms may include, for example, contacting the slurry with a solid support including the microorganisms. In some embodiments, the microorganisms may be carried by a biochemical support, such as, for example, high surface area pellets (e.g., at least 100 m²/g of surface area) comprised of one or more of a carbohydrate, a protein or a lipid.

In some embodiments, the biochemical support for microorganisms may be comprised of solid or semi-solid compounds derived from the organic slurry itself.

Operation 170 may be followed by operation 180, “Anaerobic Digestion Secondary Phase.” In operation 180, the biomass obtained in operation 170 is maintained for anaerobic digestion to occur. Operation 180 may be performed in various reactors known in the art. Non-limiting examples of reactors that may be used to perform operation 170 include an Upflow Anaerobic Sludge Blanket (UASB) reactor; a Plug Flow Reactor; a Fixed-Bed Reactor; an Anaerobic Baffled Rector (ABR); a Granular-Bed Baffled Rector (GRABBR), a sediment reactor, a Batch Reactor; a Complete-Mix Reactor; a Packed-Bed reactor, or any type of anaerobic digester that is suitable for processing the organic liquid (e.g., the pre-treated organic liquid from operation 165, or the organic liquid fraction from operation 160).

In some embodiments, operation 180 is performed using a UASB reactor. In some embodiments, operation 170 and operation 180 are performed using a UASB reactor. As an example, the UASB reactor was inoculated with granular seed provided to the Applicants (Penford Food Ingredients, Richland, Wash.); the reactor was maintained at a temperature of 30 to 37 C.° to obtain mesophilic bacterial activity; pre-treated organic liquid (e.g., provided by operation 165, such as clarified organic liquid) can be delivered via a mechanized fluid delivery system to the bottom of the reactor. The granular seed may be configured to function as a fluidized bed. The organic component of the liquid can be anaerobically digested to produce a biogas and a liquid effluent as the liquid passes upward through the fluidized bed. In some embodiments, the pH is maintained between 6.5 and 8.4. For example, the pH can be between 6.5 and 7.0; between 7.0 and 7.4; between 7.5 and 7.8, and over 7.8. In some embodiments the temperature can be maintained between 35 and 38 C°.

In some embodiments, the solid, liquid and gas phases are separated inside of the reactor via a three-phase separator. In some embodiments, biogas is produced and separated from the reactor (e.g., operation 188). In some embodiments, an effluent is produced from the reactor (e.g., operation 190). In some embodiments, the effluent has a total nitrogen content of 0.01%, a total potassium content of at least 0.01%, and a pH of at least 7.0. In some embodiments, a fraction of the effluent is recirculated through the reactor to provide for adequate upflow velocity. The upflow velocity can be maintained, for example, at a rate of at least 0.1 meters per hour (m/h); at least 0.3 m/h; at least 0.5 m/h, or at least 1.0 m/h or at least 2.0 m/h.

In some embodiments, a certain fraction of effluent from operation 190, Collecting Liquid Fraction “Base Fertilizer,” may be utilized in either operation 120, serving as an input in Forming a Slurry, or may be utilized in operation 165, serving as the diluting liquid when Pre-Treating the Organic Liquid Fraction. The use of base fertilizer to form mixtures in these cases may serve to increase the total nitrogen content of the subsequent fractions in a concentrating fashion, and may serve to increase other useful nutrients to plants including potassium, phosphorus, magnesium, calcium, iron, sulfur, manganese, chloride, nickel, cobalt, molybdenum, selenium, or zinc. In one example, utilizing the effluent produced by operation 190 as an input in operation 120 may concentrate the total nitrogen in the subsequently produced base fertilizer to at least 0.1% total nitrogen; to at least 0.2% total nitrogen; to at least 0.3% total nitrogen; to at least 0.5% total nitrogen; to at least 1.0% total nitrogen; to at least 2.0% total nitrogen; or to at least 3.0% total nitrogen. In another example, utilizing the base fertilizer produced by operation 190 as an input in operation 165 may concentrate the total nitrogen in the subsequently produced base fertilizer to at least 0.1% total nitrogen; to at least 0.2% total nitrogen; to at least 0.3% total nitrogen; to at least 0.5% total nitrogen; to at least 1.0% total nitrogen; to at least 2.0% total nitrogen; or to at least 3.0% total nitrogen.

The Applicants appreciate that insertion of base fertilizer in any operation previous to operation 190 may increase the nutrient content of the final product. Thus, in some embodiments, base fertilizer may be combined with the material at operation 110, operation 120, operation 130, operation 140, operation 160, operation 165, operation 170, or operation 180. Moreover, base fertilizer can be combined with the material at two or more of operations selected from operation 110, operation 120, operation 130, operation 140, operation 160, operation 165, operation 170, or operation 180. In some embodiments, the amount of base fertilizer that is combined is inversely proportional to the nutrient content (e.g., nitrogen content) of the liquid. For example, the nitrogen content may be determined at operation 165 and an appropriate amount of base fertilizer can be added. Generally, the lower the nutrient content, the more base fertilizer that may be combined.

The Applicants appreciate that the settled layer from operation 165 may be utilized as an input in any operation previous to operation 165 to increase the nutrient content of the final product. Thus, in some embodiments, the settled layer obtained from operation 165 can be combined with material at operation 110, operation 120, operation 130, operation 140, or operation 160. Moreover, the settled layer from operation 165 can be combined with material at two or more of operations selected from operation 110, operation 120, operation 130, operation 140, or operation 160. In some embodiments, the amount of the settled layer that is combined is inversely proportional to the nutrient content (e.g., nitrogen content) of the liquid. For example, the nitrogen content may be determined at operation 140 and an appropriate amount of sludge can be added. Generally, the lower the nutrient content, the more of the settled layer that may be combined.

As another example, utilizing the settled layer produced by operation 165 as an input in operation 120, forming a slurry, may concentrate the total nitrogen in the subsequently produced liquid organic fraction (operation 155) to at least 0.5% total nitrogen; to at least 1.0% total nitrogen; to at least 1.5% total nitrogen; to at least 2.0% total nitrogen; to at least 3.0% total nitrogen; or to at least 5.0% total nitrogen. In another example, utilizing the settled sludge produced by operation 165 as an input in operation 120 may concentrate the total nitrogen in the base fertilizer (operation 190) to at least 0.1% total nitrogen; to at least 0.2% total nitrogen; to at least 0.3% total nitrogen; to at least 0.5% total nitrogen; to at least 1.0% total nitrogen; to at least 2.0% total nitrogen; or to at least 3.0% total nitrogen.

In another example, the settled layer from operation 165 may be utilized as an input in operation 120, to similarly increase nutrient concentrations. It is to be appreciated that insertion of settled layer from operation 165 into any step previous to operation 165 may serve the effect to concentrating nutrients for which the Applicants are claiming knowledge.

The liquid effluent fraction resulting from operation 190 is a fertilizer material, and may be utilized as a fertilizer and directly applied to soils, foliage, through soil-less hydroponic systems, or other liquid fertilizer application systems when utilizing a proper application dilution, for demonstrably superior agricultural growth results when compared to industry standard fertilizer solutions.

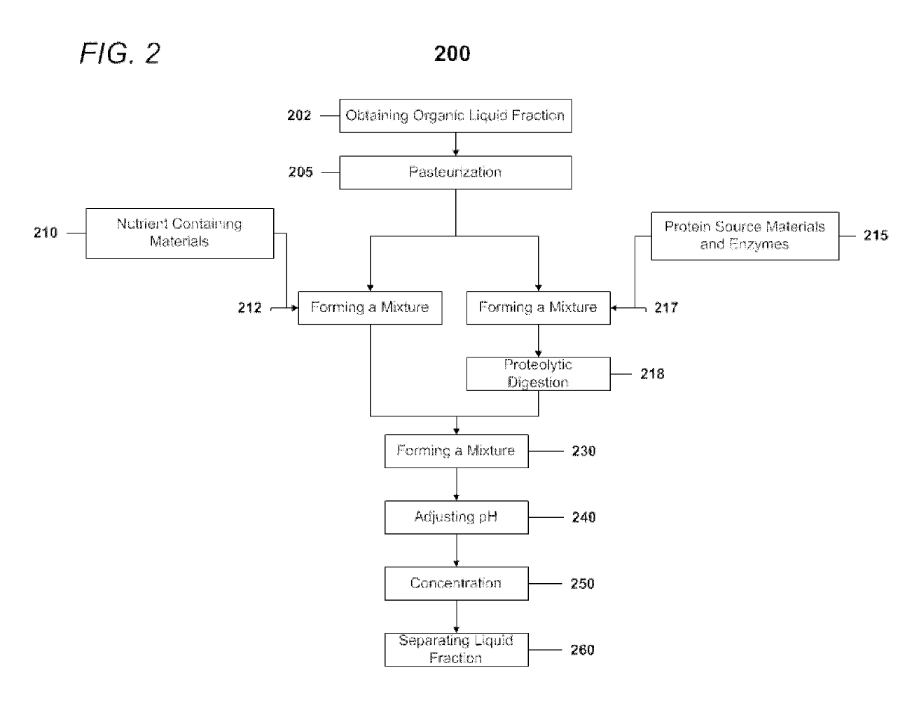

FIG. 2 is a flow diagram representing one example of method 200 for increasing the nutrient content of organic materials within the scope of the present application. As illustrated in FIG. 2 method 200 may include one or more functions, operations, or actions as illustrated by one or more operations 202-260. Operations 202-260 may include “Obtaining Organic Liquid Fraction” operation 202, “Pasteurization” operation 205, providing for “Nutrient Containing Materials” operation 210, “Forming a Mixture” operation 212, providing for “Protein Source Materials and Enzymes” operation 215, “Forming a Mixture” operation 217, “Proteolytic Digestion” operation 218, “Forming a Mixture” operation 230, “Adjusting pH” operation 240, “Concentration” operation 250, and “Separating Liquid Fraction” operation 260.

In FIG. 2, operations 202-260 are illustrated as being performed sequentially, with operation 205 first and operation 260 last, except for operations 210-212, which may be performed sequentially, concurrently, or otherwise independently from operations 215-218. It is further appreciated that operations 205-260 may be repeated, interdigitated, or otherwise re-ordered as appropriate to suit particular embodiments, and that these operations or portions thereof may be performed concurrently in some embodiments. For example, operation 260 may be performed prior to operation 230, and/or prior to operation 240, and/or prior to operation 250.

Method 200 may begin at operation 202, “Obtaining Organic Liquid Fraction.” In some embodiments, the liquid fraction can be obtained from operation 190 disclosed above. Thus, some embodiments of the present application include a process that performs method 157 and method 200. Also, some embodiments of the present application include a process that performs method 100, method 157, and method 200. In some embodiments, method 157 and method 200 can be performed at about the same location. In some embodiments, method 157 and method 200 can be performed using a system configured to perform both of these processes.

Method 200 may, in some embodiments, be completed at a different location than method 100. For example, method 100 may be completed using a first system on-site where organic material (e.g., food waste) is produced. The organic liquid fraction may then be transported (e.g., by truck) to a second system to perform method 157 and method 200. The first system and the second system may, for example, be separated by a distance of at least 1 mile; at least 5 miles; at least 10 miles; or at least 25 miles.

Operation 202, may be followed by operation 205, “Pasteurization.” Any method suitable for pasteurizing the liquid fraction (e.g., base fertilizer) can be used. The skilled artisan, guided by the teachings of the present application, can identify appropriate temperatures and time period for heating in order to pasteurize the base fertilizer. In some embodiments, the pasteurizing can include heating the liquid fraction at a pre-determined temperature for a pre-determined period of time. In some embodiments, the pre-determined temperature and pre-determined period of time are effective to reduce microbial activity in the liquid fraction. In some embodiments, the pasteurization can include heating the liquid fraction to at least about 80° C. for about two minutes.

Operation 205, “pasteurization” in some embodiments may include techniques collectively referred to as “cold sterilization techniques” known to skilled artisans where the treatment, for example by acids, alkalais or etc., are used to effectively reduce pathogenic microbial activity in the liquid fraction.

Operation 205 may be followed by operation 217, “Forming a Mixture.” In operation 217, liquid fraction from operation 205 may be combined with a protein source, and a proteolytic enzyme (from operation 215) to form a mixture. The protein source may be from vegetable material, cottonseed meal, alfalfa meal, blood meal, bone meal, hair and wool, feather meal, rendering byproducts, fish material, piggery waste, chicken eggs and egg whites, poultry manure, poultry byproducts, sheep manure, bovine manure, seabird guano, seaweed, kelp, or any organic source containing nitrogen of content higher than the base fertilizer. The proteolytic enzyme can be any protease or molecule capable of lowering the activation energy to sufficiently increase the hydrolysis of proteins and peptides, including trypsin, subtilisin, and serine proteases, neutral protease, among others.

Operation 217 may be followed by operation 218, “Proteolytic Digestion.” In operation 218, the mixture formed in operation 217 is maintained at conditions effective for proteolytic digestion to occur.

As one example, base fertilizer can be heated to about 80° C. for two to five minutes to pasteurize the liquid. Soy Supro 515 Isolate, a vegetable-based protein produced by Solae (St. Louis, Mo.), may be used as a protein source material, and Alcalase 2.4 L FG from Novozymes (Denmark), may be used as a proteolytic enzyme. Alcalase 2.4 L FG is a non-specific protease belonging to serine proteases, secreted in large amount by gram-positive Bacillus (genus) facultative anaerobes. Choice of protein source material may affect choice of proteolytic enzyme or enzymes and these factors, when guided by this disclosure, are known to practitioners skilled in the art. The protein source material was added to the base fertilizer until the total nitrogen was at least 0.5%, and the temperature of the reaction may be set to at least 40° C.; at least 50° C.; at least 60° C., or to at least 65° C. Adjustment for pH was not necessary because the Fertilizer Base provided for the proper pH for proteolytic digestion conditions.

In some embodiments, the protein source material can be added before the enzyme. In some embodiments, the enzyme and protein source material can be added at about the same time. In some embodiments, operation 218 may obtain a composition having a total nitrogen content of at least about 0.1%; at least 0.5%; at least 1.0%; at least 1.5%; at least 2%; at least 3%, at least 5%, or at least 6%. In some embodiments, the enzyme is added in about 0.05% by weight in relative to the protein source material. In another embodiment, the ratio of the enzyme to the protein source material is about 0.10%; about 0.25%; about 0.50%; about 1.0% and about 2.0%. In some embodiments, Proteolytic Digestion occurs for at least 30 minutes; for at least 1 hour; for at least 2 hours; for at least 4 hours; for at least 12 hours, and for at least 24 hours.

Without being bound to any particular method of mixing components, Applicants have discovered that proteolytic digestion was more complete when utilizing base fertilizer when forming the mixture, versus utilizing water in substitution of the base fertilizer. Also, Applicants have discovered that the biological activity of the final product of proteolytic digestion was higher when utilizing base fertilizer versus utilizing water that had been adjusted to a similar pH as the base fertilizer.

Operation 205 may also be followed by operation 210, obtaining “Nutrient Containing Materials.” The materials in operation 210 may include, but are not limited to, materials containing the following elements, nitrogen, potassium, phosphorus, magnesium, calcium, iron, sulfur, manganese, chloride, nickel, cobalt, molybdenum, selenium, silicon, zinc, or other elements necessary for healthy plant growth. For example, materials that may be used include (with substantial nutrients listed by element in parentheses) soft rock phosphate (P, Ca), seabird guano (P, K, Ca), alfalfa meal (P, K), cottonseed meal (P, K), bone meal (P, Ca), blood meal (P, Fe), feather meal (P, Ca), fish meal (P, Ca), kelp meal (P, K, S), kelp powder (P, K, S), fish powder (P, Ca), kelp extract (P, K, S), seaweed (P, K, S), calcium sulfate (Ca, S), potassium sulfate (K, S), potassium magnesium sulfate (K, S), potassium chloride (K, Cl), potassium hydroxide (K), magnesium sulfate (Mg, S), sodium borate (B), sodium tetraborate (B), copper sulfate (Cu, S), iron (ferrous) sulfate (Fe, S), elemental sulfur, iron citrate (Fe), manganese sulfate (Mn, S), sodium molybdenate (Mo), zinc sulfate (Zn, S), zinc oxysulfates (Zn, S), neem oil, gibberelic acid, humic acid citric acid, lactic acid, acetic acid, alginic acid, phosphoric acid (P), sulfuric acid (S), molasses and cane sugar. In some embodiments, the nutrient containing material is potassium magnesium sulfate. In some embodiments, the nutrient material is potassium hydroxide. In some embodiments, the nutrient material is potassium sulfate. In some embodiments, the nutrient containing material is North Atlantic kelp powder. In some embodiments, the nutrient containing material is added to water. In some embodiments, the nutrient-containing material is added to the liquid fraction to form a mixture (operation 212). In some embodiments, the nutrient material is added in sufficient amounts to obtain a total potassium concentration of at least 0.2%; at least 0.5%; at least 1.0%; at least 1.5%; at least 2.0%; at least 3.0%, or at least 5.0%.

As one non-limiting example, North Atlantic kelp powder and potassium hydroxide can be added to base fertilizer to obtain a mixture of containing potassium of at least 1% at least 2%; at least 3%; at least 4%; at least 6%, or at least 8% by weight. In some embodiments, the mixture is stirred and heated to increase solubility.

The skilled artisan, guided by the teachings of the present application, will appreciate that operations 210-218 can be combined, reordered, or deleted as appropriate depending on the desired output and processing conditions.

Operations 212 and 218 may be followed by operation 230, “Forming a Mixture.” Any ratio of the products from operation 218, “Proteolytic Digestion” and operation 212, “Forming a Mixture,” may be utilized. The ratio may be selected depending on the desired final concentration of the nutrients desired in the final product being developed.

Operation 230 may be followed by operation 240, “Adjusting pH.” Operation 240 may be performed, if necessary by adding an organic acid to the mixture from operation 230. This may include acetic acid, citric acid, tartaric acid, lactic acid, or any acid suitable for reducing the pH. In one example, 22 g of citric acid can be added to every liter of the mixture from operation 230 to obtain a material having a pH below 5.0. Operation 230 is optional depending upon the pH requirements for the final product of the process.

Operation 240 may be followed by operation 250, “Concentration.” Any method suitable and known in the art for concentrating a liquid may be employed. For example, heating, boiling, filtration, evaporation, and vacuum evaporation are several methods that can be utilized.

Operation 250 may be followed by operation 260, “Separating Liquid Fraction.” Any method suitable and known in the art for separating a liquid and a solid may be employed. For example, centrifuging, filtering, use of a screw press, hydrocyclone, membrane separation technology, or various organic or salting-out strategies for precipitationmay be utilized.

The processes described herein produces nutrient-rich fertilizers with tunable and varying concentrations of nitrogen, phosphorus, and potassium (primary nutrients), secondary nutrients, micronutrients, carbon-containing species, and biotic materials. Commercially available fertilizers are generally described by an NPK grade, which indicates the amount of nitrogen (as elemental nitrogen), phosphate (P₂O₅) and potash (K₂O) contained in the product. All three units are the weight/volume percent of the material, multiplied by 100. The appropriate fertilizer grade to utilize is determined by many factors including, but not limited to, type of crop fertilizing, growth stage of the crop fertilizing, soil type, regional climate, localized weather, as well as previous and current land management practices. In one non-limiting example, those skilled in the art will recognize that heavily irrigated turf grass on sandy soils favor a 3-1-2 fertilizer with 1% sulfur. In another non-limiting example, vegetables grown on soils with high levels of organic matter prior to harvest favor a 0-3-3 fertilizer. In another non-limiting example, rhododendrons exhibiting chlorosis in younger leaves favor a 3-1-3 fertilizer with 2% iron.

In some embodiments, the liquid effluent from the secondary phase (base fertilizer) has a total nitrogen content of at least 0.01%, and a potassium (K₂O) content of at least 0.01% (NPK grade of 0.01-0-0.01). In another embodiment, the liquid effluent from the secondary phase (base Fertilizer) has a total nitrogen content of at least 0.05%, and a potassium (K₂O) content of at least 0.05% (NPK grade of 0.05-0-0.05). A non-limiting example of a formulation resulting from operation 190 includes a fertilizer with an NPK grade of 0.1-0-0.1. In another non-limiting example, a formulation resulting from operation 190 includes a fertilizer with an NPK grade of 0.2-0.0.2.

The processes described by operation 212, forming a mixture (nutrient rich solution), and operation 218, proteolytic digestion (nitrogen rich solution), are utilized in forming a mixture in operation 230, for which the concentrations of the nutrients in the respective mixtures and the ratio of mixtures themselves are subject to the Applicant's control to formulate final products with desired NPK grades. In addition, the concentration represented by operation 250 can be utilized to produce further nutrient-augmented products (higher NPK grades) that have higher economic value, lower shipping costs, and more plant-available nutrition per unit volume.

In a non-limiting example of a liquid fertilizer resulting from operation 260, a product with an NPK grade of 2.9-0.31-1.32 was produced (see also Table 9 of Example 9).

In a non-limiting example of a liquid fertilizer resulting from operation 260, a product with an NPK grade of 3-0-1 was produced.

In a non-limiting example of a liquid fertilizer resulting from operation 260, a product with an NPK grade of 1-0-0 was produced.

In a non-limiting example of a liquid fertilizer resulting from operation 260, a product with an NPK grade of 0-0-1 was produced.

In a non-limiting example of a liquid fertilizer resulting from operation 260, a product with an NPK grade of 3-0-0 was produced.

In a non-limiting example of a liquid fertilizer resulting from operation 260, a product with an NPK grade of 0-0-3 was produced.

In a non-limiting example of a liquid fertilizer resulting from operation 260, a product with an NPK grade of 3-0-3 was produced.

In a non-limiting example of a liquid fertilizer resulting from operation 260, a product with an NPK grade of 5-0-3 was produced.

In a non-limiting example of a liquid fertilizer resulting from operation 260, a product with an NPK grade of 6-0-0 was produced.

In a non-limiting example of a liquid fertilizer resulting from operation 260, a product with an NPK grade of 6-0-2 was produced.

In a non-limiting example of a liquid fertilizer resulting from operation 260, a product with an NPK grade of 3-1-2 may be produced.

In a non-limiting example of a liquid fertilizer resulting from operation 260, a product with an NPK grade of 3-1-1 may be produced.

In a non-limiting example of a liquid fertilizer resulting from operation 260, a product with an NPK grade of 0-4-4 may be produced.

In a non-limiting example of a liquid fertilizer resulting from operation 260, a product with an NPK grade of 0-2-2 may be produced.

In a non-limiting example of a liquid fertilizer resulting from operation 260, a product with an NPK grade of 3-1-3 may be produced.

In a non-limiting example of a liquid fertilizer resulting from operation 260, a product with an NPK grade of 5-3-0 may be produced.

In a non-limiting example of a liquid fertilizer resulting from operation 260, a product with an NPK grade of 3-3-0 may be produced.

In a non-limiting example of a liquid fertilizer resulting from operation 260, a product with an NPK grade of 3-2-0 may be produced.

In a non-limiting example of a liquid fertilizer resulting from operation 260, a product with an NPK grade of 0-3-0 may be produced.

In a non-limiting example of a liquid fertilizer resulting from operation 260, a product with an NPK grade of 0-3-3 may be produced.

In a non-limiting example of a liquid fertilizer resulting from operation 260, a product with an NPK grade of 0-4-0 may be produced.

In a non-limiting example of a liquid fertilizer resulting from operation 260, a product with an NPK grade of 0-0-4 may be produced.

In a non-limiting example of a liquid fertilizer resulting from operation 260, a product with an NPK grade of 0-0-7 may be produced.

In some embodiments, operation 250 includes boiling of the solution until the removal of all remaining liquid was complete, resulting in a solid fertilizer with an NPK grade of 9-1-3.

Some embodiments disclosed herein include a system configured to perform one or more methods or operations for processing organic material.

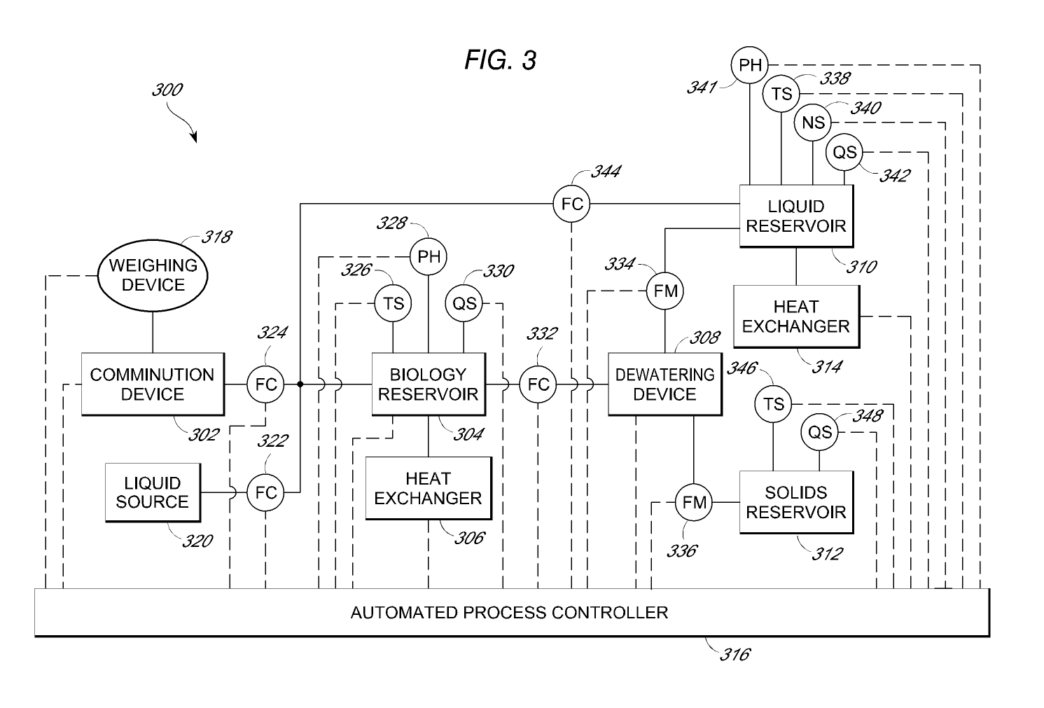

FIG. 3 is a block diagram illustrating one example of system 300 for processing organic materials within the scope of the present application. System 300 may, in some embodiments, be configured to perform any of the methods disclosed herein (e.g., method 100 depicted in FIG. 1A).

System 300 may include comminution device devices 302 which is are fluidly coupled to biology reservoir 304. As used herein, “fluidly coupled” can include any connection through one or more conduits than allows the exchange of material between two components. Two components may be fluidly coupled when one or more intermediate components receive or process a fluid that is transferred between the two components. Comminution device 302 may be used, for example, to perform all or part of operation 120 depicted in FIG. 1A. For example, organic material may be provided to the comminution device, which forms particulate and optionally combines a liquid with organic material. The comminution device may be, for example, a grinder, crusher, a mill, rotating blade, and the like.

Biology reservoir 304 may be used, for example, to perform anaerobic digestion in operation 140 as depicted in FIG. 1A. Biology reservoir 304 may be a vessel or container that stores the biomass during anaerobic digestion. In some embodiments, biology reservoir 304 includes a mixer (not shown) for mixing biomass in biology reservoir 304. Examples of a mixer include, but are not limited to, one or more rotatable blades, one or more pumps for circulating biomass, and the like. Biology reservoir 304 may be thermally coupled to heat exchanger 306 to maintain the biology reservoir at an appropriate temperature for anaerobic digestion. For example, heat exchanger 306 may maintain biology reservoir 304 at any of the temperature ranges described above with respect to the method of process organic materials. Heat exchanger 306 may include a heating unit and/or a cooling unit as appropriate to maintain the temperature. In some embodiments, heat exchanger 306 is thermally coupled to biology reservoir 304 by circulating a fluid (e.g., water) between the two components.

Dewatering device 308 is fluidly coupled to biology reservoir 304 and configured to receive biomass from biology reservoir 304. Dewatering device 308 may be, for example, one or more of a filter, a centrifuge, a screw press, a belt-filter press, and the like. In some embodiments, dewatering device 308 is configured to perform embodiments of operation 150 as depicted in FIG. 1A. Dewatering device 308 is fluidly coupled to liquid reservoir 310 and configured to provide liquid components (e.g., leachate) to liquid reservoir 310. Dewatering device 308 is also fluidly coupled to solids reservoir 312 and configured to provide solids to the solids reservoir 312. As described above with respect to the method of processing organic material, dewatering device 308 may also be configured so that solids can be retained or recirculated to biology reservoir 304 (not shown).

Liquid reservoir 310 may be fluidly coupled to biology reservoir 304. In some embodiments, liquid reservoir 310 is configured to recirculate leachate to biology reservoir 304. Liquid reservoir 310 may also be thermally coupled to heat exchanger 314. Heat exchanger 314 may be configured, for example, to maintain the temperature of liquid reservoir 310 below about 70° F. In some embodiments, heat exchanger 314 is thermally coupled to solids reservoir 312 (not shown).

System 300 may include closed structure 316 that may include biology reservoir 304, dewatering device 308, liquid reservoir 310, and solids reservoir 312. Closed structure 316 may include a finite number of inlets and outlets for the organic material, liquids, biogas, leachate, solids, etc. Closed structure 316 may limit the release of volatile organic compounds or prevent exposing the microorganisms to excess oxygen. In some embodiments, closed structure 316 is coupled to an air purifier (not shown). The air purifier may be configured to remove volatile organic compounds, hydrogen sulfide, or volatile fatty acids from the biogas. In some embodiments, the air purifier includes a carbon filter.

System 300 can include automatic process controller 316 (hereinafter “controller”) that is configured to execute instructions for processing organic material. In some embodiments, controller 316 is configured to execute instructions for processing organic material according to any of the methods disclosed in the present application (e.g., according to method 100 depicted in FIG. 1). Controller 316 may be any conventional processor, controller, microcontroller, or solid state machine. A processor may also be implemented as a combination of computing devices, e.g., a combination of a DSP and a microprocessor, a plurality of microprocessors, one or more microprocessors in conjunction with a DSP core, or any other such configuration. The steps of the method described in connection with the embodiments disclosed herein may be embodied directly in controller 316, in a software module executed by controller 316, or in a combination of the two.

Controller 316 may be in communication with weighing device 318. As used herein, “in communication” can include any configuration that permits an at least one-directional exchange of signals (e.g., data) between two components. Two components may exchange signals, for example, via a wired connection, wirelessly, or through access to shared memory (e.g., flash memory). The exchange may occur through an intermediate device, such as a separate controller. Weighing device 318 may be configured to provide the amount of organic material provided for processing. Controller 316 may determine an appropriate amount of liquid to combine with organic material based, in part, on data received from weighing device 318 (e.g., as described above with respect to operation 120 in FIG. 1). Controller 316 may combine liquids from liquid source 320 (e.g., a municipal water line or water tank) which is fluidly coupled to biology reservoir 304. Flow control device 322 is in communication with controller 316 to adjust the amount of water added when forming a slurry. As used herein, a “flow control device” can include a pump or valve and optionally other components (e.g., volumetric sensors and weighing devices) that, when in communication with a controller, can control the quantity of material transferred between two components. Thus, in some embodiments, controller 316 may be configured to form a slurry according to any of the methods described above (e.g., control the slurry composition as described for operation 120 in FIG. 1A).

Comminution device 302 may be in communication with controller 316. Controller 316 may, for example, receive signals from comminution device 302 indicating when the organic material has been comminuted. Flow control device 324 may be in communication with controller 316 and configured to adjust a flow of organic components from comminution device 302 to biology reservoir 304. For example, controller 316 may signal flow control device 324 to provide organic material to biology reservoir 304 when comminution device 302 has stopped operation.

Biology reservoir 304 can be in communication with controller 316. As an example, controller 316 may send signals to control operation of a mixer. Controller 316 may apply a pre-determined mixing protocol during anaerobic digestion and may adjust the mixing based on various events. For example, longer mixing may be applied when a new slurry is added to biology reservoir 304. As another example, mixing can be delayed when operating dewatering device 308.

Biology reservoir 304 may also include components for sensing various conditions during anaerobic digestion. Temperature sensor 326, pH sensor 328, and quantity sensor 330 (e.g., a weighing device or volumetric sensor) are configured to sense various properties in the biology reservoir. Each of these sensors may be in communication with controller 316, which may receive data concerning conditions in the biology reservoir and take appropriate steps to maintain conditions for anaerobic digestion. For example, controller 316 may receive temperature conditions from temperature sensor 326. Controller 316 may be in communication with heat exchanger 306 and adjust the operation parameters for heater exchanger 306 to adjust the temperature, if necessary. As another example, controller 316 may receive pH conditions from pH sensor 328. Controller 316 may be in communication with one or more flow control devices (not shown) for delivering pH modifying agents to adjust pH. As another example, quantity sensor 330 may provide the volume of material in biology reservoir 304 to controller 316. Controller 316 may be configured to add additional fluids (e.g., via one or more flow control devices) to maintain a desired amount of liquid relative to organic material in biology reservoir 304. In some embodiments, controller 316 is configured to maintain conditions within biology reservoir 304 according to any of the embodiments described with respect to the method of processing organic materials (e.g., embodiments relating to operation 140 in FIG. 1A).

Flow control device 332 may be configured to adjust the flow of digested biomass from biology reservoir 304 to dewatering device 308. Flow control device 332 can be in communication with controller 316. Controller 316 may be configured to control the quantity and timing of providing biomass to dewatering device 308. Controller 316 may be configured provide biomass to dewatering device 308 according to any of the embodiments described with respect to the method of processing organic materials (e.g., embodiments relating to operation 140 and 150 in FIG. 1A). Controller 316 may also be in communication with dewatering device 308 and control the operation of dewatering device 308.

Flow meter 334 is in communication with controller 316 and configured to provide flow measurements regarding the leachate provided from dewatering device 308 to liquid reservoir 310. Flow meter 336 is in communication with controller 316 and configured to provide flow measurements regarding the solids provided from dewatering device 308 to solids reservoir 312.

Liquid reservoir 310 may also include various components for sensing various conditions for the leachate. Temperature sensor 338, nutrient sensor 340, pH sensor 341, and quantity sensor 342 are configured to sense various characteristics of liquids reservoir 310. Nutrient sensor 340 may, for example, be an electrochemical sensor where electrical properties may be correlated with content of one or more nutrients. Each of these sensors may be in communication with controller 316, which can receive data regarding the leachate and make appropriate adjustments to the process. For example, if quantity sensor 342 indicates liquid reservoir 310 is full, the controller may stop providing biomass to dewatering device 308 using flow control device 332. As another example, controller 316 may receive temperature conditions from temperature sensor 338. Controller 316 may be in communication with heat exchanger 314 and adjust the operation parameters for heater exchanger 314 to adjust the temperature, if necessary. As another example, controller 316 may be in communication with pH sensor 341 and can adjust an amount leachate that is recirculated to biology reservoir 304 based on the measured pH of the leachate.

Liquid reservoir 310 may be fluidly coupled to biology reservoir 304 so that leachate may be recirculated into biology reservoir 304. Flow control device 344 may be configured to adjust the flow of leachate from liquid reservoir 310 to biology reservoir. Flow control device 344 can be in communication with controller 316. In some embodiments, controller 316 may provide an amount of leachate to biology reservoir 304 based on the amount of organic material (e.g., received from weighing device 318) and nutrient content of the leachate (e.g., received from nutrient sensor 340). Controller 316 may, for example, be configured to provide an amount of leachate to biology reservoir 304 according to any of the embodiments for the method of processing organic materials described herein (e.g., embodiments relating to operation 120 in FIG. 1A).

Solids reservoir 312 may also include various components for sensing various conditions in the solids. Temperature sensor 346 and quantity sensor 348 are configured to sense various characteristics of the solids reservoir. Each of these sensors may be in communication with controller 316, which can receive data regarding the solids and make appropriate adjustments to the process. For example, controller 316 may receive temperature conditions from temperature sensor 346. Heat exchanger 314 may be thermally coupled to solids reservoir 312 (not shown), sot that controller 316 may adjust the operation parameters for heater exchanger 314 to adjust the temperature of solids reservoir 312, if necessary. As another example, if quantity sensor 348 indicates solids reservoir 312 is full, the controller may stop providing biomass to dewatering device 308 using flow control device 332.

Controller 316 may optionally be coupled to a display screen (not shown) for displaying various characteristics of the process. Non-limiting examples for the display screen include a CRT monitor, an LCD screen, a touch-screen, an LED display, and the like. Controller 316 may display characteristics, such as temperature, pH, length of time for anaerobic digestion, quantity of biomass, quantity of leachate, quantity of solids, error messages, warning messages, and the like. Controller 316 may also be optionally coupled to an input device, such as a keyboard, mouse, touchscreen, etc. The input device may allow a user to adjust various settings or variables for controller 316 that modifies the how system 300 performs the method for processing organic material.

In some embodiments, controller 316 may be coupled to a communication device (not shown) for communicating with a remote system or user. The communication device is not particularly limited and can be, for example, a cellular modem, a land-line modem, a wifi device, and ethernet modem, and the like. Controller 316 may send data for system 300 via the communication device to a remote site or user. For example, the controller 316 may send error reports when one or more operating conditions are outside acceptable thresholds. In some embodiments, a user can remotely configure or control system 300 by sending signals to controller 316 via the communication device.

Some embodiments disclosed herein include a system configured to perform method 157. The system may, for example, include a reactor fluidly coupled to, and configured to receive, an organic liquid fraction source. In some embodiments, the reactor is a UASB reactor. The reactor may also be fluidly coupled to a biogas reservoir that is configured to receive gas from the reactor. The reactor may also be fluidly coupled to a liquid effluent reservoir (or base fertilizer reservoir) that is configured to receive liquid effluent from the reservoir. In some embodiments, the system may include an automatic process controller (hereinafter “controller”) that is configured to execute instructions for performing method 157. The controller may be in communication with the reactor and control the conditions for the second-phase anaerobic digestion (e.g., as disclosed above with regard to operation 180). The controller may also be in communication with one or more flow control devices and control fluid flow between the components of the system. For example, the controller may be in communication with a flow controller that controls the amount of dilution in operation 165. The controller may also optionally be in communication with various pH sensors and quantity sensors to measure various characteristics of the process (e.g., measure pH of materials in the reactor). The controller may also optionally be in communication with one or more heat exchangers configured to adjust the temperature in the reactor.

Some embodiments disclosed herein include a system configured to perform method 200. The system may include, for example, a pasteurizer, a proteolytic digester, one or more mixers, a concentrating device, and a liquid separation device. For example, the pasteurizer may be configured to perform operation 205. The one or more mixers may be configured to perform any of operation 212, operation 217, and/or operation 230. The concentrating device may be configured to perform operation 250. The liquid separation device may be configured to perform operation 260. In some embodiments, the system may include a controller that is configured to execute instructions for performing method 200. The controller may be in communication with the pasteurizer and control the conditions for pasteurization (e.g., as disclosed in operation 205). The controller may be in communication with one or more mixer and optional one or more flow controllers to combine nutrient-containing materials, protein sources, enzymes with the pasteurized liquid (e.g., as disclosed in operation 210, operation 212, operation 215, operation 217, and operation 230). The controller may also be in communication with the proteolytic digester and control conditions for proteolytic digestions (e.g., as disclosed in operation 218). The controller may also be in communication with a pH sensor for adjusting the pH (e.g., as disclosed in operation 240). The controller may also be in communication with the concentrating device and liquid separation device.

Some embodiments disclosed herein include a system configured to perform method 157 and method 200. The system can include the combined components from the two systems discussed above for performing method 157 and method 200. The system may include a single controller that is configured to execute instructions for performing method 157 and method 200.

The steps of a method described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

### EXAMPLES

Additional embodiments are disclosed in further detail in the following examples, which are not in any way intended to limit the scope of the present application.

### Example 1

Chemical and physical properties of Food Waste, operation 110, are listed in Table 1. Food waste was procured from PCC Natural Markets (Issaquah, Wash.), and subject to comminution via a custom grinding mechanism. The grinder ensures particle size is optimal and is capable of processing animal bones, glass, plastic, and most kitchen cooking utensils. The values for COD, TN, TAN, Alkalinity, pH, TS, VS, and Total Phosphorus of the food waste component of OFMSW are found commonly in scientific literature. The values for Consistency, Odor and Color in TABLE 1, and also TABLES 2 through 8, if any, were determined using qualitative senses by the Applicants, and consistent with metrics that one skilled in the art would use to be able to recognize and to also qualitatively characterize said materials in a similar fashion.

The Total Solids (TS) content of the solution can be determined by centrifuging the sample for 15 minutes at no less than 4,000 RPM; decanting the liquid layer into a suitable container such as an aluminum crinkle dish, exposing the sample to 105° C. for about 8 hours, and accurately weighing the sample both before and after heating. The Volatile Solids (VS) content of the solution can be determined by exposing the sample resulting from the finished TS test to a muffle furnace at 550° C. for a period of at least 7 hours, and weighing the sample before and after said procedure. The VS/TS value represents the component of TS that is made up of VS by weight, and is the quotient of the two individual values, and expressed as a percent. This procedure applies to all Examples where a TS, VS and VS/TS value applies.

TABLE 1

| Parameter | Observation | Units |
|---|---|---|
| Consistency | Solid | |
| Odor | No | |
| Color | Varies | |
| Density | 0.95 | Kilograms per Liter |
| Chemical Oxygen | 370 | Grams of Oxygen per Liter |
| Demand (COD) | | |
| Total Nitrogen (TNTN) | 0.85% | Percent (Weight/Volume) |
| Total Ammonium | 0.12% | Percent (Weight/Volume) |
| Nitrogen (TAN) | | |
| Alkalinity | 3.48 | Grams CaCO₃ per Liter |
| pH | 3.82 | |
| Total Solids (TS) | 30.3% | Percent (Weight/Weight) |
| Volatile Solids (VS) | 28.8% | Percent (Weight/Weight) |
| VS/TS | 95.0% | Percent (Weight/Weight) |
| Elemental Potassium | 0.6% to 2.4% | Percent (Weight/Volume) |
| Total Phosphorus | 0.10% | Percent Phosphate (PO₄³⁻), |
| | | (Weight/Volume) |

### Example 2

Chemical and physical properties of the method of operation 150, “Dewatering,” are assembled in TABLE 2. Operation 150 in the present application may be the same as operation 150 as disclosed in U.S. application Ser. No. 13/191,251. Several of the chemical properties can be determined via commercially available tests. The COD was determined using part number TNT825 test kit from Hach Company (Loveland, Colo.). The TN was determined utilizing part number TNT826 test kit from the same vendor. The TAN was determined for the liquid organic layer utilizing TNT832 test kit from the same vendor. The Total Alkalinity was determined utilizing part number TNT870 test kit from the same vendor. The Volatile Acids was determined utilizing part number TNT872 test kit from the same vendor. All samples utilizing the Hach Company test kits are measured utilizing a spectrophotometer (part number DR 2800), from the same company. This procedure applies to Example 2 through Example 8 where a COD, TN, TAN, Total Alkalinity, and/or Volatile Acids value applies.

TABLE 2

| Parameter | Observation | Units |
|---|---|---|
| Consistency | Slurry | |
| | Liquid | |
| Odor | Yes | |
| Color | Brown | |
| Chemical Oxygen | 103 | Grams of Oxygen per Liter |
| Demand (COD) | | |
| Total Nitrogen (TN) | 0.60% | Percent (Weight/Volume) |
| Total Ammonium | 0.11% | Percent (Weight/Volume) |
| Nitrogen (TAN) | | |
| Volatile Acids | 27.9 | Equivalent Grams |
| | | Acetic Acid per Liter |
| Alkalinity | 6.6 | Grams CaCO₃ per Liter |
| pH | 4.89 | |
| Electroconductivity | 15 | Millisiemens per Centimeter |
| Total Solids (TS) | 14.5% | Percent (Weight/Weight) |
| Volatile Solids (VS) | 13.3% | Percent (Weight/Weight) |
| VS/TS | 91.7% | Percent (Weight/Weight) |

### Example 3

Chemical and physical properties of a method (settling) of Pre-Treating Organic Liquid Fraction, operation 165, are presented in TABLE 3. The pre-treated organic liquid (e.g., resulting from operation 160) was allowed to settle via gravity for a time period of at least 24 hours, in order to separate the liquid into a sludge layer and a settled layer. A sample was prepared by removing at least 20 mL of the settled layer into a suitable container for sampling, and centrifuging at a speed of at least 4,000 rpm for 15 minutes. The liquid layer was decanted and tested as previously described in EXAMPLES 1 through 2.

TABLE 3

| Parameter | Observation | Units |
|---|---|---|
| Consistency | Thick Liquid | |
| Odor | Yes | |
| Color | Orange/Brown | |
| Chemical Oxygen | 86 | Grams of Oxygen per Liter |
| Demand (COD) | | |
| Total Nitrogen (TN) | 0.43% | Percent (Weight/Volume) |
| Total Ammonium | 0.10% | Percent (Weight/Volume) |
| Nitrogen (TAN) | | |
| Volatile Acids | 21.5 | Equivalent Grams |
| | | Acetic Acid per Liter |
| Alkalinity | 4 | Grams CaCO₃ per Liter |
| pH | 5 | |
| Electroconductivity | 14 | Millisiemens per Centimeter |
| Total Solids (TS) | 5.0% | Percent (Weight/Weight) |
| Volatile Solids (VS) | 3.8% | Percent (Weight/Weight) |
| VS/TS | 76.0% | Percent (Weight/Weight) |

### Example 4

Chemical and physical properties of a method (clarification) of Pre-Treating Organic Liquid Fraction, operation 165, are presented in TABLE 4. The pre-treated organic liquid (e.g., resulting from operation 160) was diluted with dechlorinated water. Tap water can be effectively dechlorinated (removal of the OCl⁻ anion) by allowing an aliquot of tap water to stand open to the atmosphere for period of at least 24 hours, or by the addition of 13 mg of sodium thiosulfate per gallon of tap water treated. The liquid organic fraction was diluted with water to achieve a COD value of 10 grams per liter. The Total Potassium was determined for the Pre-treating Organic Liquid Fraction utilizing part number 2459100 test kit from Hach Company (Loveland, Colo.). The sample value was measured utilizing a spectrophotometer (part number DR 2800), from the same company. This procedure applies to Example 4 through Example 8 where a Total Potassium value applies.

TABLE 4

| Parameter | Observation | Units |
|---|---|---|
| Consistency | Liquid | |
| Odor | Musty Odor | |
| Color | Pale Orange | |
| Chemical Oxygen | 10 | Grams of Oxygen per Liter |
| Demand (COD) | | |
| Total Nitrogen (TN) | 0.05% | Percent (Weight/Volume) |
| Total Ammonium | 0.01% | Percent (Weight/Volume) |
| Nitrogen (TAN) | | |
| Volatile Acids | 2.5 | Equivalent Grams |
| | | Acetic Acid per Liter |
| Alkalinity | 0.47 | Grams CaCO₃ per Liter |
| Electroconductivity | 1.6 | Millisiemens per Centimeter |
| Total Solids (TS) | 0.6% | Percent (Weight/Weight) |
| Volatile Solids (VS) | 0.4% | Percent (Weight/Weight) |
| VS/TS | 76.0% | Percent (Weight/Weight) |
| Elemental Potassium | 0.05% | Percent (Weight/Volume) |

### Example 5

A method of “Collecting Liquid Fraction (“Base Fertilizer”),” operation 190, is described as follows. A Granular Bed Anaerobic Baffled Reactor (GRABBR) with 100 gallons of liquid capacity was charged with an inoculum of mesophilic seed granules from Penford Food Ingredients (Richland, Wash.) to a volume of about 80 gallons, and the remainder with water. The reactor was maintained at 35° C. continuously. A settled liquid similar to the solution in depicted in TABLE 3 (EXAMPLE 3) was added continuously at a rate of 10 grams of COD, per liter of reactor (seed granule) volume, per day. Recirculation of liquid inside the reactor was maintained at 1 L/min via a peristaltic pump. Operation continued for several days to maintain healthy reaction conditions as determined by methane production and stable pH equal to about 7.8. Data from a sample of the effluent (base fertilizer) are presented in TABLE 5:

TABLE 5

| Parameter | Observation | Units |
|---|---|---|
| Consistency | Liquid | |
| Odor | Earthy Smell | |
| Color | Light Yellow | |
| Density | 1.00 | Kilograms per Liter |
| Chemical Oxygen | 6.24 | Grams of Oxygen per Liter |
| Demand (COD) | | |
| Total Nitrogen (TN) | 0.05% | Percent (Weight/Volume) |
| Total Ammonium | 0.012% | Percent (Weight/Volume) |
| Nitrogen (TAN) | | |
| Volatile Acids | 0.01 | Equivalent Grams |
| | | Acetic Acid per Liter |
| Alkalinity | 0.5 | Grams CaCO₃ per Liter |
| pH | 7.8 | |
| Electroconductivity | 14 | Millisiemens per Centimeter |
| Total Solids (TS) | 0.58% | Percent (Weight/Weight) |
| Volatile Solids (VS) | 0.01% | Percent (Weight/Weight) |
| VS/TS | 1.7% | Percent (Weight/Weight) |
| Elemental Potassium | 0.05% | Percent (Weight/Volume) |

### Example 6

A method of “Forming a Mixture” (operation 212) is described as follows. To 668 mL of pasteurized base fertilizer (operation 190, described in EXAMPLE 5), 132 grams of North Atlantic kelp powder (Acadian Seaplants Ltd., Nova Scotia, Canada) and 66.5 grams of potassium hydroxide (Cascade Columbia, Seattle, Wash.) were added. The mixture was heated to 50° C. and allowed to stir for 3 hours. Data from a sample of the effluent mixture are presented in TABLE 6:

TABLE 6

| Parameter | Observation | Units |
|---|---|---|
| Consistency | Thick Liquid | |
| Odor | Slightly | |
| | Sour | |
| Color | Dark Purple | |
| Total Nitrogen (TN) | 0.13% | Percent (Weight/Volume) |
| pH | 14 | |
| Total Solids (TS) | 22.5% | Percent (Weight/Weight) |
| Volatile Solids (VS) | 5.1% | Percent (Weight/Weight) |
| VS/TS | 22.7% | Percent (Weight/Weight) |
| Elemental Potassium | 7.20% | Percent (Weight/Volume) |

### Example 7

A method of “Proteolytic Digestion” (operation 218) is described as follows. To 720 mL of pasteurized base fertilizer (operation 205, described in EXAMPLE 5), about 70 grams of soy protein isolate (Solae, St. Louis, Mo.) and 10 grams of Alcalase 2.4 L FG (Novozymes, Denmark) were added. The mixture was allowed was maintained at 60° C. and allowed to gently stir for about 3 hours. Data from a sample of the effluent mixture are presented in TABLE 7:

TABLE 7

| Parameter | Observation | Units |
|---|---|---|
| Consistency | Liquid | |
| Odor | Mildly Sweet | |
| Color | Light Brown | |
| Chemical Oxygen | 142 | Grams of Oxygen per Liter |
| Demand (COD) | | |
| Total Nitrogen (TN) | 1.4% | Percent (Weight/Volume) |
| Total Ammonium | 0.18% | Percent (Weight/Volume) |
| Nitrogen (TAN) | | |
| Volatile Acids | 12 | Equivalent Grams |
| | | Acetic Acid per Liter |
| Total Solids (TS) | 10.1% | Percent (Weight/Weight) |
| Volatile Solids (VS) | 9.4% | Percent (Weight/Weight) |
| VS/TS | 93.1% | Percent (Weight/Weight) |
| Elemental Potassium | 0.09% | Percent (Weight/Volume) |

### Example 8

Chemical and physical properties of a method of “Separating Liquid Fraction” (operation 260) are presented in TABLE 8. The sample was prepared by combining the product of operation 212, “Forming a mixture” (detailed in EXAMPLE 6), and the product of operation 218, “Proteolytic Digestion” (detailed in EXAMPLE 7), in about a 5% to 95% ratio, respectively, by volume. To the solution, about 16 g of citric acid was added to adjust the hydrogen ion activity to about a pH of 5. The solution was heated to 100° C. while continuously stirring, and allowed to remain at this temperature until the total solution volume reached 40% of the original volume. The Total Phosphorus was determined for the Separated Liquid Fraction by utilizing part number TNT845 test kit from Hach Company (Loveland, Colo.). The sample value was measured utilizing a spectrophotometer, (part number DR 2800), from the same company. This sample is representative of a concentrated fertilizer product.

TABLE 8

| Parameter | Observation | Units |
|---|---|---|
| Consistency | Liquid | |
| Odor | Sweet & | |
| | Sour | |
| Color | Dark Brown | |
| Density | 1.13 | Kilograms per Liter |
| Chemical Oxygen | 397 | Grams of Oxygen per Liter |
| Demand (COD) | | |
| Total Nitrogen (TN) | 3.8% | Percent (Weight/Volume) |
| Total Ammonium | 0.23% | Percent (Weight/Volume) |
| Nitrogen (TAN) | | |
| Volatile Acids | 45.6 | Equivalent Grams |
| | | Acetic Acid per Liter |
| Alkalinity | 21 | Grams CaCO₃ per Liter |
| pH | 5.5 | |
| Total Solids (TS) | 26.9% | Percent (Weight/Weight) |
| Volatile Solids (VS) | 22.5% | Percent (Weight/Weight) |
| VS/TS | 83.6% | Percent (Weight/Weight) |
| Elemental Potassium | 0.90% | Percent (Weight/Volume) |
| Total Phosphorus | 0.12% | Percent Phosphate (PO₄³⁻), |
| | | (Weight/Volume) |

### Example 8

Comparison of the detailed chemical composition properties of; a method of “Dewatering” (operation 150); a method of “Collecting Liquid Fraction (“Base Fertilizer”),” (operation 190); and a method of “Separating Liquid Fraction” (operation 260), produced as described in Example 2, Example 5 and Example 7, respectively, are presented in TABLE 9. The sample represented by operation 260 is representative of a concentrated fertilizer product. Testing was performed by a third party professional laboratory testing vendor (AmTest Laboratories, Kirkland, Wash.).

TABLE 9

| Operation (From | | | |
|---|---|---|---|
| FIGS. 1a, 1b | | 190 | 260 |
| and 2) | 150 | Fertilizer | Fertilizer |
| Description | Dewatering | Base | Product |
| Ammonia | 1,200 | 1,300 | 4,400 |
| Total Nitrogen | 5,700 | 1,500 | 29,000 |
| Nitrate & Nitrite | 7.7 | 0.75 | 18 |
| Organic Nitrogen | 4,500 | 200 | 24,600 |
| Calcium | 1,500 | 64 | 360 |
| Potassium | 2,800 | 1,400 | 11,000 |
| Magnesium | 260 | 23 | 130 |
| Sodium | 1,230 | 539 | 3,700 |
| Silver | <0.52 | <0.12 | <2.4 |
| Aluminum | <0.52 | <0.12 | 200 |
| Arsenic | <0.52 | <0.12 | <2.37 |
| Boron | <2.62 | <0.61 | 23.9 |
| Barium | 0.04 | 0.04 | 0.85 |
| Beryllium | <0.0262 | <0.0061 | <0.118 |
| Cadmium | <0.02616 | <0.00606 | <0.1185 |
| Cobalt | 0.11 | 0.03 | <0.237 |
| Chromium | 0.34 | <0.012 | 0.38 |
| Copper | 0.13 | <0.012 | 2.85 |
| Iron | 724 | 0.8 | 224 |
| Lithium | <0.262 | <0.061 | <1.18 |
| Manganese | 7.34 | 0.07 | 2.42 |
| Molybdenum | 0.35 | <0.061 | <1.18 |
| Nickel | <0.262 | 0.27 | <1.18 |
| Phosphorus | 1020 | 29.6 | 1220 |
| Lead | <0.52 | <0.12 | <2.37 |
| Sulfur | 430 | 21.3 | 1340 |
| Antimony | <0.52 | <0.12 | <2.37 |
| Selenium | <0.52 | <0.12 | <2.37 |
| Silicon | 25.3 | 6.9 | 229 |
| Tin | 0.8 | 0.25 | <1.18 |
| Strontium | 1.9 | 0.17 | 2.22 |
| Titanium | <0.052 | <0.012 | 7.27 |
| Thallium | <0.52 | <0.12 | <2.37 |
| Vanadium | <0.262 | <0.061 | <1.18 |
| Yttrium | <0.0262 | <0.0061 | 0.12 |
| Zinc | 5.57 | 0.04 | 5.36 |
| Mercury | 0.0056 | <0.004 | <0.01 |

### Example 10

In one example, WISErg base fertilizer was tested in a greenhouse for efficacy on plant growth and compared to Hoagland and water as a control. Hoagland Solution is a scientifically recognized fertilizer mixture that contains known concentrations of every necessary element for plant growth (Hoagland and Arnon, 1950). Application of WISErg base fertilizer and Hoagland solution were added in equal nitrogen concentrations and similar total liquid volumes. In the control, water was added in similar liquid volume. The applications were performed at an off-site facility in a controlled, single-blind experiment. Base fertilizer achieved 48.3% greater root biomass, as defined by below-ground biomass measured in dry weight, for Spring Wheat (Triticum aestivum) cultivar Buck Pronto, and when compared to Hoagland Solution (see TABLE 10).

TABLE 10
Roots (Relative weight)

| | |
|---|---|
| Control (Water) | 1.0 |
| Hoagland Solution | 1.3 |
| WISErg base fertilizer | 2.0 |

In this same experiment, base fertilizer achieved 11.8% greater shoot biomass, as defined by above ground biomass, measured in dry weight, and when compared to the Spring Wheat treated with Hoagland Solution (see TABLE 11).

TABLE 11
Shoots (Relative weight)

| | |
|---|---|
| Control (Water) | 1.0 |
| Hoagland Solution | 2.3 |
| WISErg Base Fertilizer | 2.6 |

### Example 11

Food waste was collected from a local grocery store, consisting of produce, deli and meat scrap waste. Without sorting, the food waste was ground into a slurry containing an average particle size of less than about 0.5 cm and combined. On the first day (Day 1), in a closed system having 500 g of food waste, 660 g of mesophilic seed (Penford Food Ingredients, Richland, Wash.) and 500 g of deionized water were added and the slurry was well mixed. The biology reservoir was kept at 35 to 37° C. for 24 hours allowing the bacteria to incubate and decompose the slurry. On Day 2, 160 mL of leachate was dewatered through a screen press, 500 g of ground food was added and 160 mL of deionized water was also added. This same operation was performed on Day 3, Day 4, Day 5 and Day 6. On Day 7, 80% of the remaining contents of the slurry were dewatered.

The Total Kjeldahl Nitrogen (“TKN”) test was determined using known methods (Hach CompoantTest Component, Product #TNT826) for each leachate sample to determine the total percent weight of nitrogen in the sample. The results are listed in TABLE 12.

TABLE 12

| Day # | N (% weight) |
|---|---|
| Day 2 | 0.75 |
| Day 3 | 0.97 |
| Day 4 | 0.89 |
| Day 5 | 0.90 |
| Day 6 | 1.00 |
| Day 7 | 0.92 |

The nitrogen content of the leachate was effectively being concentrated over the period from Day 2 through Day 6 and a maximum N concentration of 1.0% being indicated on Day 6.

A trace metal analysis of the leachate was performed by a third party chemical testing service and the results are provided in TABLE 13.

TABLE 13

| Element | PPM* |
|---|---|
| Potassium (K) | 2,800.00 |
| Calcium (Ca) | 1,500.00 |
| Sodium (Na) | 1,230.00 |
| Phosphorus (P) | 1,020.00 |
| Iron (Fe) | 724.00 |
| Sulfur (S) | 430.00 |
| Magnesium (Mg) | 260.00 |
| Silicon (Si) | 25.3 |
| Manganese (Mn) | 7.34 |
| Zinc (Zn) | 5.57 |
| Strontium (Sr) | 1.90 |
| Tin (Sn) | 0.80 |
| Molybdenum (Mo) | 0.35 |
| Chromium (Cr) | 0.34 |
| Copper (Cu) | 0.13 |
| Cobalt (Co) | 0.11 |
| Barium (Ba) | 0.04 |

*PPM (parts per million). Equivalent units are grams per mililiter (g/mL) and micrograms
per gram (μg/g).

### Example 12

The same procedure was employed as in Example 1, except for the difference of adding 700 g of water on Day 1, and 200 g of water at each point from Day 2 through Day 6. The TKN of each dewatered leachate sample on Days 2 through Day 6 were measured and the results are listed in TABLE 14.

TABLE 14

| Day # | N (% weight) |
|---|---|
| Day 2 | 0.16 |
| Day 3 | 0.37 |
| Day 4 | 0.40 |
| Day 5 | 0.75 |
| Day 6 | 0.42 |
| Day 7 | 0.35 |

The total nitrogen content of the leachate continued to increase each day until Day 5 in this instance, and the overall nitrogen concentrations measured were lower, presumably due to the diluting effect of the additional water utilized in the hydration model.

What is claimed is:

1. A system for processing organic materials comprising:
a comminution device fluidly coupled to a biology reservoir;
a weighing device configured to weigh an amount of organic materials provided to the biology reservoir;
a dewatering device fluidly coupled to the biology reservoir, wherein the dewatering device is configured to at least partially separate liquid components from a composition received from the biology reservoir;
a solids reservoir fluidly coupled to the dewatering device and configured to receive solid components from the dewatering device;
a liquid reservoir fluidly coupled to the dewatering device and configured to receive liquid components from the dewatering device, wherein the liquid reservoir is fluidly coupled to the biology reservoir and configured to return liquid components to the biology reservoir; and
a housing having a closed interior portion, wherein the closed interior portion comprises at least the biology reservoir, the solids reservoir and the liquid reservoir.

2. The system of claim 1, further comprising a first heat exchanger thermally coupled to the biology reservoir.

3. The system of claim 1, further comprising a first water inlet configured to fluidly couple a water source to the biology reservoir via a first flow control device.

4. The system of claim 3, further comprising an automated process controller in communication with the weighing device and the first flow control device, wherein the automatic process controller is configured to adjust an amount of water in the biology reservoir based on an amount and/or biological characteristics of organic material measured by the weighing device.

5. The system of claim 1, further comprising an air purification system operably coupled to the interior portion of the housing.

6. The system of claim 4, further comprising a second flow control device operably coupled between the biology reservoir and the dewatering device, wherein the second flow control device is in communication with the automated process controller and configured via the automated process controller to adjust a flow of a digested biomass from the biology reservoir to the dewatering device.

7. The system of claim 4, further comprising a weighing device configured to weigh an amount of organic materials provided to the biology reservoir.

8. The system of claim 7, wherein:
a first temperature sensor configured to measure a temperature of the biology reservoir and in communication with the automated process controller; and
the first heat exchanger is in communication with the automated process controller and configured to maintain the temperature of the biology reservoir in a range of about 77° F. to about 105° F.

9. The system of claim 4, wherein:
a second temperature sensor configured to measure a temperature of the liquid reservoir and in communication with the automated process controller; and
the second heat exchanger is in communication with the automated process controller and configured to maintain the temperature of the liquid reservoir at no more than about 70° F.

10. A system for enriching organic materials, the system comprising:
a pasteurizer comprising an inlet port, wherein the inlet port is configured to receive an organic liquid fraction;
a proteolytic digester fluidly coupled to the pasteurizer;
a concentrating device fluidly coupled to the proteolytic digester; and
a liquid separation device fluidly coupled to the concentrating device.

11. The system of claim 10, further comprising:
a reactor comprising an inlet port, wherein the inlet port is configured to receive a second organic liquid fraction; and
a biogas reservoir fluidly coupled to the reactor,
wherein the reactor is fluidly coupled to the pasteurizer and configured to provide a liquid to the pasteurizer.

12. The system of claim 10, further comprising an automated process controller in communication with the pasteurizer and configured to maintain a pre-determined temperature in the pasteurizer.

13. The system of claim 12, wherein the pre-determined temperature is at least about 80° C.

14. The system of claim 1, further comprising an enzyme reservoir fluidly coupled to to the biology reservoir.

15. The system of claim 10, further comprising an enzyme reservoir fluidly coupled to the proteolytic digester via a first flow control device, and a protein source reservoir fluidly coupled to the proteolytic digester via a second flow control device.

16. The system of claim 14, further comprising an automated process controller in communication with the first flow control device and the second flow control device, wherein the automated process controller is configured to provide a pre-determined ratio of protein source from protein source reservoir and enzyme from the enzyme reservoir into the proteolytic digester.

17. The system of claim 16, wherein the pre-determined ratio is at least about 0.05% by weight of the enzyme relative to the protein source.

18. A method of processing organic materials, the method comprising:
providing an organic liquid fraction, wherein the organic liquid fraction is derived at least in part from microbial digestion of an organic waste;
combining the organic liquid fraction with microorganisms;
digesting the organic liquid fraction in reactor;
separating a liquid component from digested materials in the reactor;
combining the liquid component with a protein source and an enzyme; and
proteolytically digesting the protein source to form a nitrogen-enriched liquid component.

19. The method of claim 18, wherein combining the organic liquid fraction with microorganisms comprises combining microorganisms carried by a solid or semi-solid support with the organic liquid fraction.

20. The method of claim 19, wherein the solid or semi-solid support is derived at least in part from a microbially digested organic slurry obtained from the biology reservoir.

21. The method of claim 18, wherein the organic liquid fraction has a total solids of no more than about 10% by weight, 5% by weight, or 1% by weight.
